(19) United States
(12) Patent Application Publication
(10) Pub. No.: US 2025/0317171 A1
(43) Pub. Date: Oct. 9, 2025

(54) REINFORCEMENT LEARNING OF INTERFERENCE-AWARE BEAM PATTERN DESIGN

(71) Applicant: ARIZONA BOARD OF REGENTS ON BEHALF OF ARIZONA STATE UNIVERSITY, Scottsdale, AZ (US)

(72) Inventors: Ahmed Alkhateeb, Chandler, AZ (US); Yu Zhang, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 18/702,052

(22) PCT Filed: Oct. 26, 2022
(86) PCT No.: PCT/US2022/078725

§ 371 Date: Apr. 17, 2024

Related U.S. Application Data
(60) Provisional application No. 63/272,356, filed on Oct. 27, 2021.

(51) Int. Cl. H04B 7/06; G06N 3/0499

(52) U.S. Cl. CPC H04B 7/0617; G06N 3/0499

(57) ABSTRACT

Reinforcement learning of interference-aware beam pattern design is provided. Employing large antenna arrays is a characteristic of millimeter wave (mmWave) and terahertz (THz) communication systems. Embodiments described herein provide an efficient deep reinforcement learning based beam pattern design algorithm that achieves interference awareness. This is done by not requiring the channel knowledge of both desired user and the interference users. Simulation results show that the developed solution is capable of finding a well-shaped beam pattern that significantly suppresses the interference while sacrificing only negligible beam-forming/combining gain from the desired user, based only on power measurements. Furthermore, a platform and results based on real measurements are also presented, which indicates the effectiveness and robustness of the disclosed interference-aware beam pattern design approach in a practical system.

### CROSS REFERENCE TO RELATED APPLICATIONS

This application claims priority to U.S. Provisional Application No. 63/272,356 filed on Oct. 27, 2021, the entirety of which is incorporated herein by reference.

### GOVERNMENT SUPPORT

This invention was made with government funds under Grant No. 1923676 awarded by the National Science Foundation. The government has certain rights in the invention.

### FIELD OF THE DISCLOSURE

The present disclosure relates to beamforming in multi-antenna communications systems.

### BACKGROUND

Deploying a large number of antennas is crucial in enabling millimeter wave (mmWave) and terahertz (THz) communications. By applying beamforming/combining, mmWave/THz systems are able to combat the severe path loss incurred in the high frequency bands and hence provide sufficient receive signal power. To reduce the high cost and power consumption of mixed-circuit components, on the one hand, these systems start to seek either fully analog or hybrid architecture to achieve such potential. On the other hand, the adoption of such architectures also introduces several difficulties in the following signal processing, one of which is channel estimation. As a result, pre-defined codebooks (such as beamsteering codebooks) are normally used for both initial access and data transmission. Being pre-defined, however, those beams are normally designed in a way that focuses solely on improving the beamforming/combining gain from specific directions, without taking interference into account. This raises issues in situations where there are interference users in the surrounding environment, communicating at the same time-frequency slots. Those “interference-agnostic” beams might incur severe interference from other users, which could possibly degrade the system performance to a great extent.

### SUMMARY

Reinforcement learning of interference-aware beam pattern design is provided. Employing large antenna arrays is a key characteristic of millimeter wave (mmWave) and terahertz (THz) communication systems. Due to hardware constraints and lack of channel knowledge, codebook-based beamforming/combining is normally adopted to achieve the desired array gain. However, most of the existing codebooks focus only on improving the gain of its target user, without taking interference into account, which normally incurs strong performance degradation. Embodiments described herein provide an efficient deep reinforcement learning based beam pattern design algorithm that achieves interference awareness. This is done by not requiring the channel knowledge of both desired user and the interference users.

Simulation results show that the developed solution is capable of finding a well-shaped beam pattern that significantly suppresses the interference while sacrificing only negligible beamforming/combining gain from the desired user, based only on power measurements. Furthermore, an initial prototyping platform and some results based on real measurements are also presented, which indicates the effectiveness and robustness of the disclosed interference-aware beam pattern design approach in a practical system.

An exemplary embodiment provides a method for designing an interference-aware beam pattern. The method includes measuring a channel having an interference source, using reinforcement learning to shape an interference-aware beam to reduce interference in a direction of the interference source, and communicating over the channel using the interference-aware beam.

Another exemplary embodiment provides a beam pattern design framework. The framework includes a measurement module configured to measure interference on a channel, a learning module configured to use reinforcement learning to learn a beam pattern which reduces interference on the channel, and a beamforming control module configured to apply the beam pattern to communicate with a user device.

Another exemplary embodiment provides a communications system. The communications system includes a transceiver and control circuitry coupled to the transceiver. The control circuitry is configured to measure a channel having an interference source, use reinforcement learning to shape an interference-aware beam to reduce interference in a direction of the interference source, and communicate over the channel using the interference-aware beam.

Another exemplary embodiment provides a radio frequency (RF) device. The RF device includes an RF transmitter, an RF receiver co-located with the RF transmitter, and control circuitry. The control circuitry is configured to measure self-interference between the RF transmitter and the RF receiver and use reinforcement learning to design a beam pattern or beam codebook that reduces the self-interference and optimizes a performance parameter of the RF device.

According to examples of the present disclosure, a method for designing an interference-aware beam pattern is disclosed. The method comprises measuring one or more channels for one or more interfering signals from one or more interference directions; using reinforcement learning to shape one or more interference-aware beams to reduce interference in one or more directions based on the one or more interfering signals; and communicating over the one or more channels using the one or more interference-aware beams.

The method for designing an interference-aware beam pattern can include one or more of the following additional features including but are not limited to the following features. The measuring further comprises measuring, by a base station, a power level of a received signal from a target user equipment of a target user and measuring an interference power level of one or more undesired transmitters. The measuring, by the base station, the power level of the received signal from the target user equipment of the target user further comprises measuring a power of an interference plus a noise level signal when the target user equipment is not transmitting and measuring a power of a signal plus the interference plus the noise level signal of the target user equipment using a same beam produced by the target user equipment. The power of the interference plus the noise level signal when the target user equipment is not transmitting is obtained from a zero power reference signal transmitted by the target user equipment. The reinforcement learning comprises an actor-critic-based deep reinforcement learning architecture. The actor-critic-based deep reinforcement learning architecture comprises a fully connected (FC) feed-forward neural network.

According to examples of the present disclosure, a beam pattern design system is disclosed. The beam pattern design system comprises a measurement module configured to measure interference on a channel; a learning module configured to use reinforcement learning to learn a beam pattern which reduces interference on the channel; and a beamforming control module configured to apply the beam pattern to communicate with a user device.

The beam pattern design system can include one or more of the following additional features including but are not limited to the following features. The measurement module is configured to measure, by a base station, a power level of a received signal from a target user equipment of a target user and measuring an interference power level of one or more undesired transmitters. The base station measures the power level of the received signal from the target user equipment of the target user by measuring a power of an interference plus a noise level signal when the target user equipment is not transmitting and measuring a power of a signal plus the interference plus the noise level signal of the target user equipment using a same beam produced by the target user equipment. The power of the interference plus the noise level signal when the target user equipment is not transmitting is obtained from a zero power reference signal transmitted by the target user equipment. The reinforcement learning comprises an actor-critic-based deep reinforcement learning architecture. The actor-critic-based deep reinforcement learning architecture comprises a fully connected (FC) feed-forward neural network.

According to examples of the present disclosure, a communications system is disclosed. The communication system comprises a transceiver; and control circuitry coupled to the transceiver and configured to: measure a channel having an interference source; use reinforcement learning to shape an interference-aware beam to reduce interference in a direction of the interference source; and communicate over the channel using the interference-aware beam.

According to examples of the present disclosure, a radio frequency (RF) device is disclosed. The RF device comprises an RF transmitter; an RF receiver co-located with the RF transmitter; and control circuitry configured to: measure self-interference between the RF transmitter and the RF receiver; and use reinforcement learning to design a beam pattern or beam codebook that reduces the self-interference and optimizes a performance parameter of the RF device.

The RF device can include one or more of the following additional features including but are not limited to the following features. The performance parameter comprises a power for a desired user. The measure further comprises measuring, by a base station, a power level of a received signal from a target user equipment of a target user and measuring an interference power level of one or more undesired transmitters. The measuring, by the base station, the power level of the received signal from the target user equipment of the target user further comprises measuring a power of an interference plus a noise level signal when the target user equipment is not transmitting and measuring a power of a signal plus the interference plus the noise level signal of the target user equipment using a same beam produced by the target user equipment. The the power of the interference plus the noise level signal when the target user equipment is not transmitting is obtained from a zero power reference signal transmitted by the target user equipment. The reinforcement learning comprises an actor-critic-based deep reinforcement learning architecture. The actor-critic-based deep reinforcement learning architecture comprises a fully connected (FC) feed-forward neural network.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of a disclosed interference-aware beam pattern design framework with deep reinforcement learning according to embodiments described herein.

FIG. 2A is a graphical representation of beam pattern learning results in an environment with two interference users, where the learned beam pattern ignores the surrounding interference users.

FIG. 2B is a graphical representation of beam pattern learning results in the environment of FIG. 2A, where the learned beam pattern is interference-aware.

FIG. 2C is a graphical representation of beam pattern learning results in the environment of FIG. 2A, showing the learning process of FIG. 2B.

FIG. 3A is an image illustrating an exemplary prototype setup of the interference-aware beam pattern learning system.

FIG. 3B is an image illustrating a top view of the prototype setup of FIG. 3A.

FIG. 4A is a graphical representation of receive power measurements with the transmitter and interferer of FIG. 3A off.

FIG. 4B is a graphical representation of receive power measurements with the transmitter on and the interferer off.

FIG. 4C is a graphical representation of receive power measurements with the transmitter off and the interferer on.

FIG. 4D is a graphical representation of receive power measurements with the transmitter and the interferer on.

FIG. 5 is a graphical representation of signal power, interference power, and signal-to-interference ratio (SIR) as a function of iteration.

FIG. 6 is a flow diagram illustrating a process for designing an interference-aware beam pattern.

FIG. 7 shows the considered uplink scenario where a mmWave base station, operating in a receive mode, is communicating with its target user under the presence of non-cooperative interference transmitters.

FIG. 8 shows an illustration of the operation flow of the disclosed interference-aware beam pattern learning solution, where the signal power is estimated by configuring the desired UE to transmit the signal in an on/off fashion.

FIG. 9 shows an illustration of the disclosed surrogate model assisted interference-aware beam pattern learning framework.

FIG. 10A, FIG. 10B, FIG. 10C show the beam pattern learning results in an environment with two interfering transmitters, where (FIG. 10A) shows the learned beam pattern when ignoring the surrounding interfering transmitters, and (FIG. 10B) shows the interference-aware beam pattern. (FIG. 10C) shows the interference-aware beam pattern learning process.

FIG. 11A and FIG. 11B show the prediction accuracy of different surrogate model architectures. It shows that the disclosed signal model-based prediction network requires much less data samples to outperform the FC-based prediction network in both cases, i.e., the base station equipping (FIG. 11A) M=8 antennas, and (FIG. 11B) M=256 antennas.

FIG. 12A and FIG. 12B show the learning experience of the DRL agent when interacting with (FIG. 12A) the actual environment and (FIG. 12B) the surrogate model trained with 1000 data samples.

FIG. 13A and FIG. 13B show the prototyping setup and the outdoor measurement environment for evaluating the disclosed interference-aware beam pattern design algorithm.

FIG. 14A, FIG. 14B, FIG. 14C shows the learning results of the interference-unaware beam pattern, where (FIG. 14A) shows the real-time power measurement, (FIG. 14B) shows the anechoic chamber setup for measuring the learning beam pattern, and (FIG. 14C) shows the learned beam pattern with the black dashed line representing the direction of the desired signal and the red dashed lines representing the directions of the interfering sources.

FIG. 15A, FIG. 15B, FIG. 15C, FIG. 15D, FIG. 15E, FIG. 15F, FIG. 15G, FIG. 15H, and FIG. 151 show measurement results of the three experiments illustrated in FIG. 13B, where the first column of figures shows the real-time receive power measurements and the second column of figures shows the corresponding SIR and INR performance.

FIG. 16 is a block diagram of a computer system suitable for implementing the interference-aware beam pattern design framework according to embodiments disclosed herein.

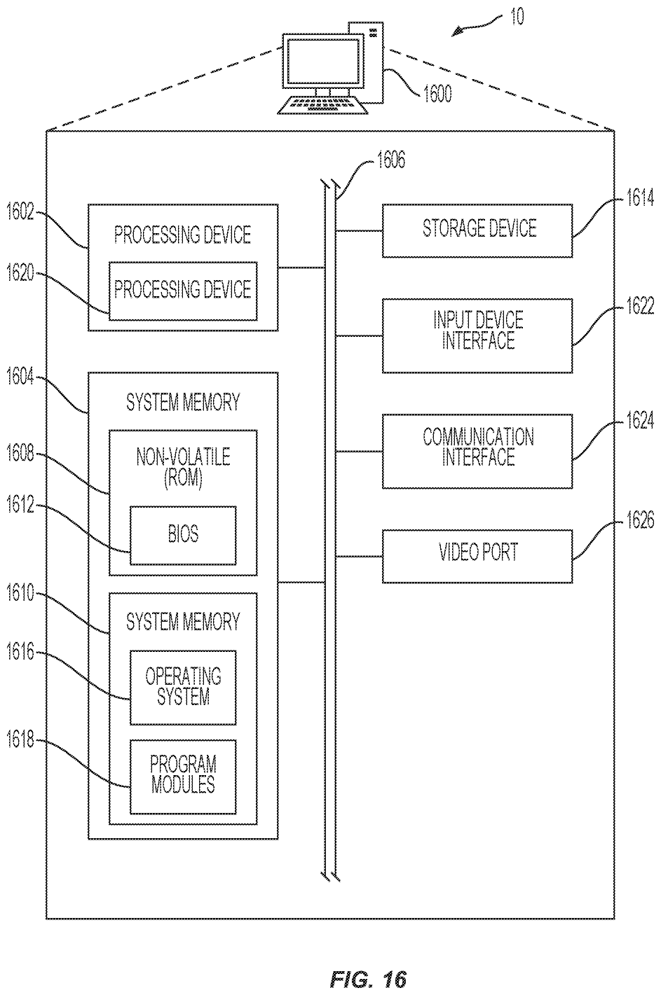

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Reinforcement learning of interference-aware beam pattern design is provided. Employing large antenna arrays is a key characteristic of millimeter wave (mmWave) and terahertz (THz) communication systems. Due to hardware constraints and lack of channel knowledge, codebook-based beamforming/combining is normally adopted to achieve the desired array gain. However, most of the existing codebooks focus only on improving the gain of its target user, without taking interference into account, which normally incurs strong performance degradation. Embodiments described herein provide an efficient deep reinforcement learning based beam pattern design algorithm that achieves interference awareness. This is done by not requiring the channel knowledge of both desired user and the interference users.

Simulation results show that the developed solution is capable of finding a well-shaped beam pattern that significantly suppresses the interference while sacrificing only negligible beamforming/combining gain from the desired user, based only on power measurements. Furthermore, an initial prototyping platform and some results based on real measurements are also presented, which indicates the effectiveness and robustness of the disclosed interference-aware beam pattern design approach in a practical system.

### I. Introduction

An ideal beam pattern design algorithm should be able to strike a balance between the desired user and interference users, targeting the signal-to-interference-plus-noise ratio (SINR) as its final objective. This disclosure presents a deep reinforcement learning-based beam pattern design framework that can efficiently adapt the beam pattern to avoid interference from surroundings while maximizing the beamforming/combining gain of the desired user. This is done by not requiring the channel knowledge of both target user and the interference users, and by only relying on the power measurements. The disclosed framework also respects the key hardware constraints such as quantized phase shifter constraint, making it a hardware compatible solution.

Simulation results show that the disclosed solution is capable of forming a beam pattern that can strike a balance between the beamforming/combining gain of the target user and the suppression gain of the surrounding interference users. By comparing with the interference-agnostic beams, it shows that the interference-aware beam can decrease the interference level from around 10 dB to 30 dB with only sacrificing the gain of target user of 5 dB. A prototyping platform and the real measurements are also presented, which shows the effectiveness of the disclosed solution in a practical setting.

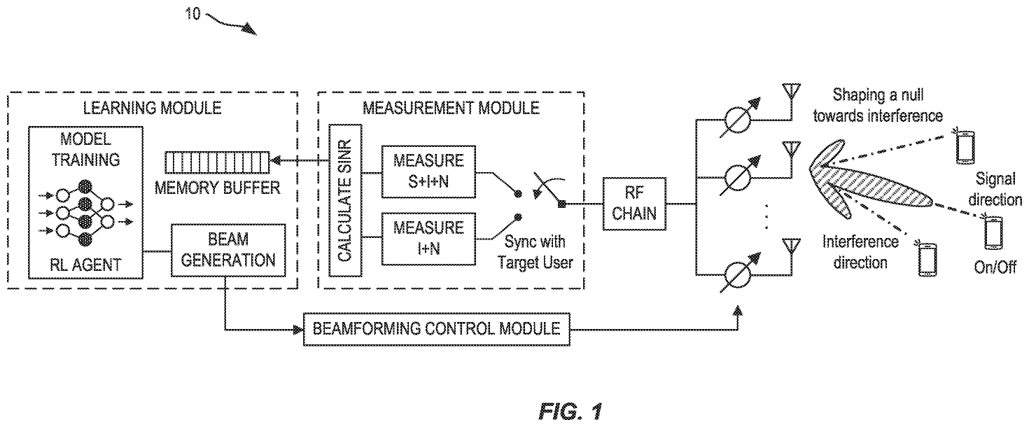

FIG. 1 is a schematic diagram of a disclosed interference-aware beam pattern design framework 10 with deep reinforcement learning according to embodiments described herein.

### II. System and Channel Models

### A. System Model

The present disclosure considers a system where a mmWave MIMO base station (BS) equipped with M antennas is communicating with a single-antenna user. Further, a practical system is considered where the BS has only one radio frequency (RF) chain and employs analog-only beamforming/combining using a network of r-bit quantized phase shifters. Furthermore, practical situations are considered where the system suffers from interference from the other co-existing communication links. To be more specific, it is assumed that there exist K(>1) single-antenna users in its surrounding transmitting signals at the same time-frequency slots, which causes interference.

Therefore, based on the above system model, the beamforming/combining vector at the BS can be written as

$$w = {\frac{1}{\sqrt{M}} [ {e}^{j {θ}_{1}} , {e}^{j {θ}_{2}} , … , {e}^{j {θ}_{M}} ]}^{T} \qquad Equation 1$$

where each phase shift θₘ is selected from a finite set Θ with 2^{r} possible discrete values drawn uniformly from (−π, π]. In the uplink transmission, if the target user transmits a symbol x ∈ [symbol] to the base station, and the other K interference users also transmit symbols xₖ ∈ [symbol] , k=1, . . . , K at the same time-frequency slot, where all the transmitted symbols satisfy the average power constraint [symbol] [|x|²]−Pₓ, the received signal at the base station after combining can be expressed as

$$y = {w}^{H} h x + {\sum }_{k = 1}^{K} {w}^{H} {h}_{k} {x}_{k} + {w}^{H} n \qquad Equation 2$$

where h ∈ [symbol] ^{M} is the channel between the base station and the target user, hₖ ∈ [symbol] ^{M} is the channel between the base station and the k-th interference user, and n˜ [symbol] (0, σ²I) is the receive noise vector at the base station.

### B. Channel Model

A narrow band geometric channel model is adopted for both the channel between the base station and the target user as well as the channels between the base station and the interference users. Without loss of generality, it is assumed that the signal propagation between all the users and the base station consists of L paths. Each path [symbol] has a complex gain [symbol] and an angle of arrival [symbol] . Then, the channel vector can be written as

$$h = {\sum }_{ℓ = 1}^{L} {α}_{ℓ} a ( {ϕ}_{ℓ} ) \qquad Equation 3$$

where a( [symbol] ) is the array response vector of the base station to the signal with an angle of arrival of [symbol] .

### III. Problem Definition

Given the receive signal at the base station, the achievable rate of the target user can be written as

$$R = {log}_{2} ( 1 + \frac{{\vert {w}^{H} h \vert}^{2}}{{\sum }_{k = 1}^{K} {\vert {w}^{H} {h}_{k} \vert}^{2} + {σ}^{2}} ) \qquad Equation 4$$

Embodiments seek to design the combining vector w such that the achievable rate of the target user can be maximized, which is equivalent to maximize the SINR. Therefore, the problem can be formulated as

$${w}_{opt} = {arg max}_{w} \frac{{\vert {w}^{H} h \vert}^{2}}{{\sum }_{k = 1}^{K} {\vert {w}^{H} {h}_{k} \vert}^{2} + {σ}^{2}} \qquad Equation 5$$

$$s . t . {w}_{m} = \frac{1}{\sqrt{M}} {e}^{j {θ}_{m}} , ∀ m = 1 , … , M \qquad Equation 6$$

$${θ}_{m} ∈ Θ , ∀ m = 1 , … , M \qquad Equation 7$$

where wₘ is the m-th element of the combining vector.

Equation 5 is very hard to be solved by using the traditional optimization methods for the following reasons. First, the constraint of Equation 6 requires unit-modulus on all the elements of the combining vector, which is non-convex. Besides, to respect the discrete phase shifter hardware constraint, wₘ can only take finite values based on all the possible phase shifts given by Equation 7. Second, h is unknown. This is because h is very hard to be accurately estimated in practice given the fully-analog architecture, as well as the possible hardware impairments. Third, hₖ is also unknown. This is because normally there is no coordination between the interference user and the base station. Therefore, hₖ is also nearly impossible to acquire.

However, a closer look at the objective function of Equation 5 indicates that knowing the channels of both target user and interference users is not necessary in order to evaluate the performance of a combining vector. In fact, SINR performance of a beam is simply determined by the combining gain (or equivalently, receive power) of the target user as well as the overall interference level caused by possibly “magnifying” the receive signals from other interference users. Fortunately, it is relatively easy and more robust to acquire receive power measurements for both desired signal and interference level, which requires significantly less control signaling compared to the complex channel estimation process.

Therefore, the problem is cast as developing a machine learning approach that learns how to design an interference-aware beam pattern w that solves Equation 5 given only receive power measurements for the interference plus noise, Σₖ|w^{H}hₖ|²+σ², and the signal plus interference and noise, |w^{H}h|²+Σₖ|w^{H}hₖ|²+σ².

### IV. Disclosed Reinforcement Learning Solution

This section presents the disclosed learning algorithm for addressing the interference-aware beam pattern design problem of Equation 5. It is worth mentioning that, in theory, Equation 5 can be solved by using exhaustive search, since it features a searching problem over a finite space as mentioned before. However, because the size of the searching space is growing exponentially with respect to the number of antennas, with the base being the number of possible phase shifts, exhaustive search is precluded quickly for even small-scale systems. For example, a system with 8 antennas and 3-bit phase shifters can form a total number of over 1.6×10⁷ different beamforming/combining vectors. Therefore, this disclosure considers leveraging the powerful exploration capability of reinforcement learning to efficiently search over the space to find the optimal or near-optimal beam pattern.

### A. Reinforcement Learning Setup

To solve the problem with reinforcement learning, all the ingredients of Equation 5 are first fit into a general reinforcement learning framework as follows:
State: The state sₜ is defined as a vector that consists of the phases of all the phase shifters at the t-th iteration, that is, sₜ=[θ₁, θ₂, . . . , θ_{M}]^{T}. This phase vector can be converted to the actual combining vector w by applying Equation 1. Since all the phases in sₜ are selected from Θ, and all the phase values in Θ are within (−π, π], Equation 1 essentially defines a bijective mapping from the phase vector to the combining vector. Therefore, for simplicity, the term “combining vector” is used to refer to both this phase vector and the actual combining vector (the conversion is given by Equation 1), according to the context.
Action: The action at is defined as the element-wise changes to all the phases in sₜ. Since the phases can only take values in {+1, −1}, a change of a phase represents the action that a phase shifter selects a value from Θ. Therefore, the action is directly specified as the next state, i.e., sₜ+₁=aₜ, which can be viewed as a deterministic transition in the Markov Decision Process (MDP).
Reward: A binary reward mechanism is defined, i.e., the reward rt takes values from {+1, −1}. Since the objective of Equation 5 is to maximize the SINR performance, the SINR achieved by the current combining vector, denoted by SINRₜ, is compared with the previous SINRₜ₋₁. The reward is computed using the following rule: rt=+1, if SINRₜ>SINRₜ₋₁; rₜ=−1, otherwise.

The above reinforcement learning formulation is fully compatible with the original problem of Equation 5 in the following sense. First, since the state and action are defined directly as the phase shift of each phase shifter, the constraints of Equations 6 and 7 are automatically satisfied. Besides, to get the reward, the objective function of Equation 5 needs to be evaluated, which can be done in a way that does not rely on channel state information of both the target user and the interference users, as will be illustrated in the following subsection.

### B. Deep Learning Architecture

An actor-critic based deep reinforcement learning architecture is adopted. More details about this learning framework can be found at Yu Zhang, Muhammad Alrabeiah, and Ahmed Alkhateeb, “Reinforcement Learning of Beam Codebooks in Millimeter Wave and Terahertz MIMO Systems,” 2021. To put it in simple words, both actor and critic networks are implemented by using simple fully-connected feed-forward neural networks. The input of the actor network is state and the output is action, while the critic network takes in the state-action pair and outputs the predicted Q value. Therefore, both the input and output size of the actor network are M, i.e., the number of antennas, while the critic network has an input size of 2M and an output size of 1. Both actor and critic networks have two hidden layers in the considered architecture, with the size of the first hidden layer being 16 times of the input size and the second hidden layer being 16 times of the output size in both networks.

Finally, as can be seen from the discrete phase shifter hardware constraint of Equation 7, only phase values within Θ can be implemented. However, since a neural network is adopted as the actor network, each element of the predicted action, i.e., the predicted phase, is essentially a continuous quantity which is highly probably not in Θ. Therefore, an element-wise quantization is performed to make the predicted action a valid one.

To be more specific, assume that it is the predicted action from the actor network. Then the action that finally gets implemented to the system is given by

$${[ {a}_{t} ]}_{m} = {arg max}_{θ ∈ Θ} \vert {[ {\hat{a}}_{t} ]}_{m} - θ \vert , ∀ m = 1 , … , M \qquad Equation 8$$

where [aₜ]ₘ denotes the m-th element of the vector aₜ. It is worth mentioning that due to the non-differentiability of the quantization operation, it is only activated during the forward pass. In the backward pass, it is simply treated as an identity layer and the gradient from the previous layer is passed through it.

### C. Practical System Operation

As can be seen, the adopted reward mechanism determines reward value based on SINR performance of the previous beam and the current beam. In order to evaluate the SINR, as shown in the objective function of Equation 5, the system needs to know the combining gains, or equivalently, receive power measurements, of both the target user and the other interference users. Given that the base station can only coordinate with the target user, this can be achieved by asking the target user to transmit uplink pilot in an on-and-off fashion.

To be more specific, once the base station forms a new beam w, it first requires the target user to be muted, in order to measure the interference plus noise level, i.e.,

$${P}_{I + N} = + {\sum }_{k = 1}^{K} {\vert {\tilde{w}}^{H} {h}_{k} \vert}^{2} + {σ}^{2} .$$

Then, the target user starts transmitting uplink pilot, and the base station can determine the receive power of the target user, by subtracting the previous power level P_{I+N} from the new power measurement

$${P}_{S + I + N} = {\vert {\tilde{w}}^{H} {h}_{k} \vert}^{2} + {\sum }_{k = 1}^{K} {\vert {\tilde{w}}^{H} {h}_{k} \vert}^{2} + {σ}^{2} .$$

Therefore, the SINR can be simply obtained by (P_{S+I+N}−P_{I+N})/P_{I+N}, based on which the reward signal can be generated. The complete pseudo code of the algorithm is given in Algorithm 1.

Algorithm 1 Deep Reinforcement Learning Based
interference-aware Beam Pattern Learning

| | |
|---|---|
| 1: | Initialize actor network μ(s)(θ^{μ}) and critic network |
| | [symbol] (s, a\| [symbol] ) with random weights θ^{μ} and [symbol] |
| 2: | Initialize the replay memory [symbol] , minibatch size [symbol] |
| 3: | Initialize a random process [symbol] for action exploration |
| 4: | Initialize the initial state s₁, the initial previous SINR level |
| | SINR₀ = 0 |
| 5: | for t = 1 to T do |
| 6: | Receive a predicted action from actor network with |
| | exploration noise âₜ = μ(sₜ, θ^{μ}) + [symbol] ₜ |
| 7: | Quantize the predicted action to a valid combining |
| | vector aₜ |
| 8: | Use combining vector aₜ |
| 9: | Mute the target user and measure the interference plus |
| | noise level |
| 10: | Receive pilots from the target user and calculate the |
| | SINR level |
| 11: | Generate reward rₜ and update state to sₜ₊₁ = aₜ |
| 12: | Update the previous SINR SINRₜ |
| 13: | Store the transition (sₜ, aₜ, rₜ, sₜ₊₁) in [symbol] |
| 14: | Sample a random mini batch of [symbol] transitions |
| | ${\{ ( {s}_{b} , {a}_{b} , {r}_{b} , {s}_{b} + 1 ) \}}_{b = 1}^{B} from 𝒟$ |
| 15: | Calculate target y_{b} = r_{b} + γ [symbol] (s_{b+1}, μ′ (s_{b+1}\|θ^{μ′} )\| [symbol] ) |
| 16: | Update the critic network by minimizing the mean |
| | $squared loss L = \frac{1}{B} {\sum }_{b} {( {𝓎}_{b} - Q ( {s}_{b} , {a}_{b} \vert {θ}^{Q} ) )}^{2}$ |
| 17: | Update the actor network using the sampled policy |
| | gradient given by |
| | ${- \frac{1}{B} {\sum }_{b = 1}^{B} {∇}_{a} Q ( s , a ) {\vert}_{s = {s}_{b} , a = μ ( {s}_{b} \vert {θ}^{μ} )} {∇}_{{θ}^{μ}} μ ( s \vert {θ}^{μ} ) \vert}_{s = {s}_{b}}$ |
| 18: | end for |

### V. Simulation Results

This section evaluates the performance of the disclosed reinforcement learning based interference-aware beam pattern learning algorithm. The simulation considers a base station equipped with a uniform linear array that has 8 antenna elements and half-wavelength antenna spacing, where each antenna is followed by a 3-bit analog phase shifter. For a better demonstration, the following simulation steps are adopted. First, the channel of the target user is generated based on Equation 3, where, for simplicity, the case when the user only has a line-of-sight (LOS) connection with the base station is considered, i.e., L=1 in Equation 3.

The system then learns a beam pattern when there is no interference and this learned beam is referred to as an “interference-agnostic” beam since it focuses on maximizing the combining gain of the desired signal. After this beam is learned, the simulation intentionally puts the interference users at the directions aligning with the strongest side lobes of the learned beam, and also assumes that they only have LOS channels with the considered base station, which causes non-negligible interference. The system then takes the interference into account and an “interference-aware” beam is re-designed that learns how to manage the interference in such a way that improves the SINR performance.

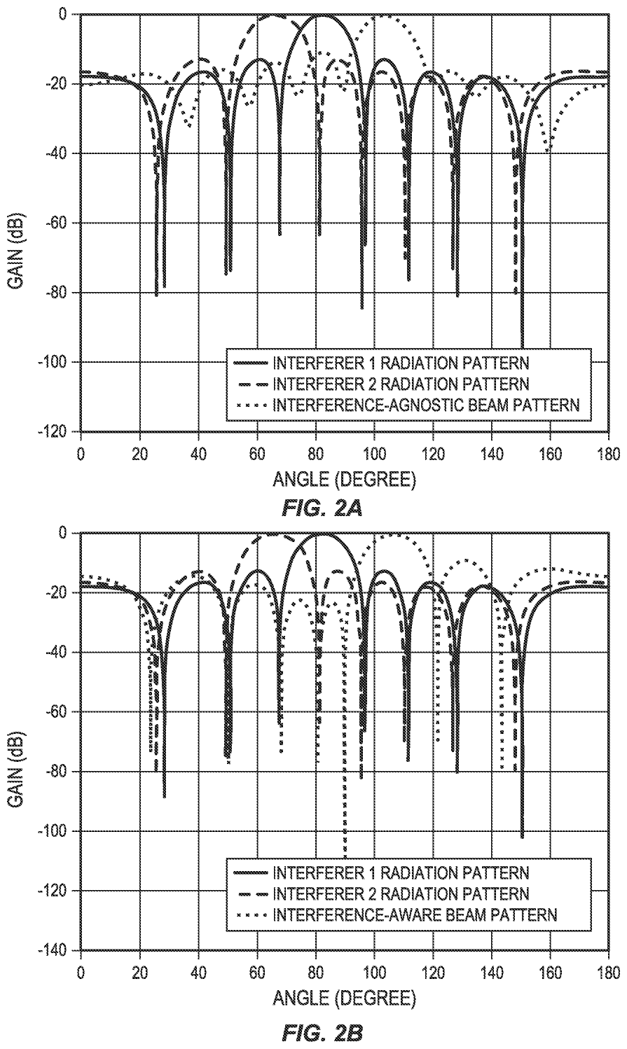

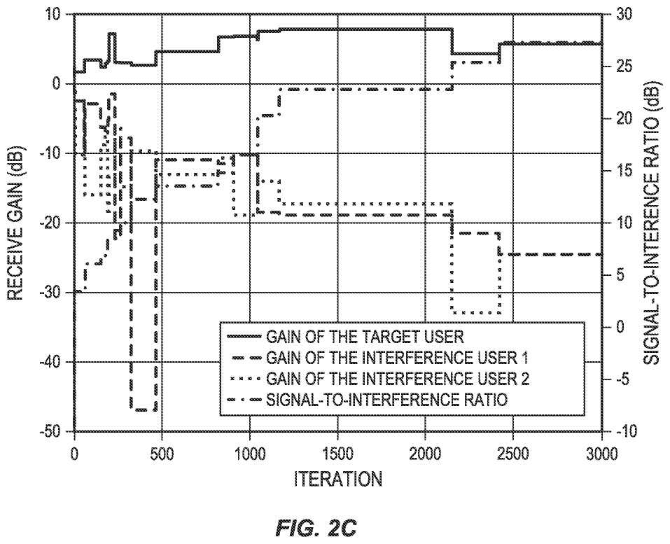

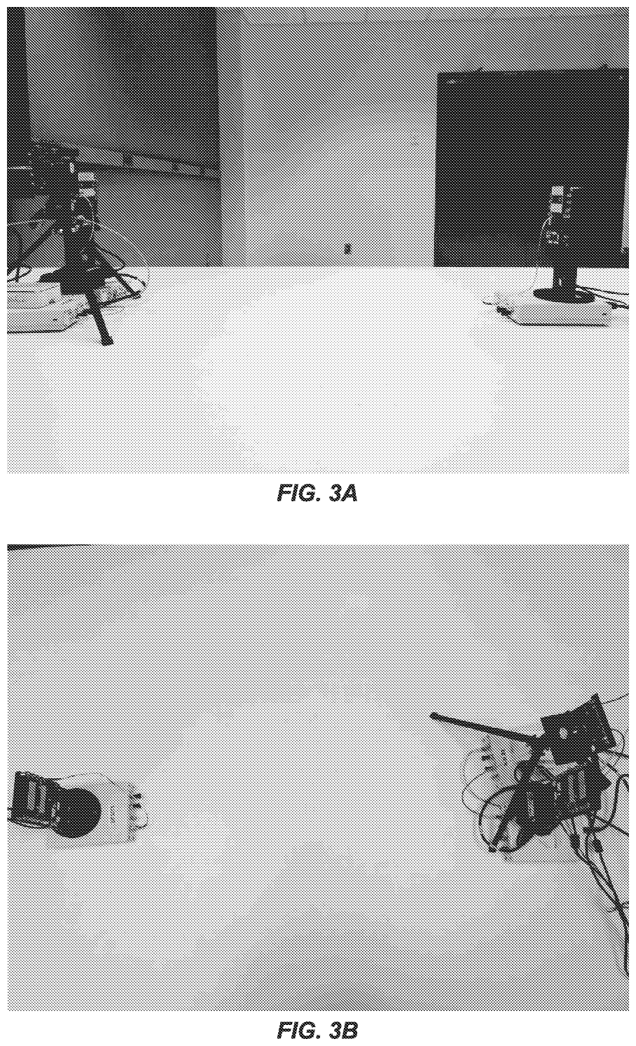

FIG. 2A is a graphical representation of beam pattern learning results in an environment with two interference users, where the learned beam pattern ignores the surrounding interference users. FIG. 2B is a graphical representation of beam pattern learning results in the environment of FIG. 2A, where the learned beam pattern is interference-aware. FIG. 2C is a graphical representation of beam pattern learning results in the environment of FIG. 2A, showing the learning process of FIG. 2B.

FIGS. 2A-2C demonstrate the learning results when there are two interference users and further show the beam patterns learned with and without taking the interference into account, together with the receive patterns (i.e., the distribution of receive power strength in angular domain at the base station) of the selected interference users. As shown in FIG. 2A, the two interferers are present at the directions aligning with the two strongest side-lobes of the interference-agnostic beam, which incurs significant interference and causes performance degradation. The learned interference-aware beam is plotted in FIG. 2B. Clearly, unlike the interference-agnostic beam, the interference-aware beam maintains quite low gain side lobes at the directions where the interferers show up, which help manage the severe interference. To be more specific, in the interference-agnostic case, the signal-to-interference ratio (SIR) levels are 10.56 dB and 13.71 dB with respect to the two interference users. By contrast, the SIR levels are improved to 28.63 dB and 26.28 dB when using the interference-aware beam, which only incurs a loss of 0.8348 dB for the combining gain of the target user.

FIG. 2C shows how the combining gains of the received signals from the target user and interference users are changing as the learning proceeds, as well as the overall SIR performance. As can be seen, the combining gain of the target user and the combining gains of the two interference users start from almost the same level, since a random beam is used as the starting point. As learning proceeds, the combining gain of the target user maintains, generally speaking, an increasing trend, while the combining gains of the two interference users are gradually decreasing. Due to the specific reward mechanism used herein, i.e., focusing solely on improving the SIR performance, the overall SIR maintains a monotonically increasing trend.

Furthermore, as can be observed from the figure, the combining gain of the target user has a very high spike at the beginning of the learning process. However, due to the poor performance on suppressing the interference of that beam, it is quickly deprecated by other beams that have lower combining gain to the target user but are very effective in controlling the interference. FIG. 2C also shows that with only around 1000 iterations, the SIR performance is able to be improved from around 10 dB to around 20 dB, without knowing the channels (for both target user and the interference users).

### VI. Real Measurement Results

This section evaluates the performance of the disclosed reinforcement learning based interference-aware beam pattern learning algorithm on a real prototyping platform.

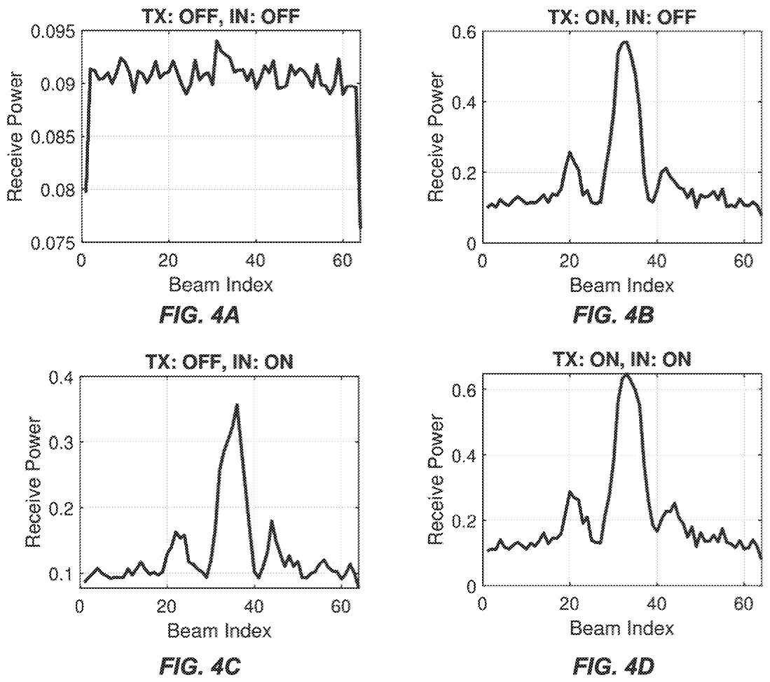

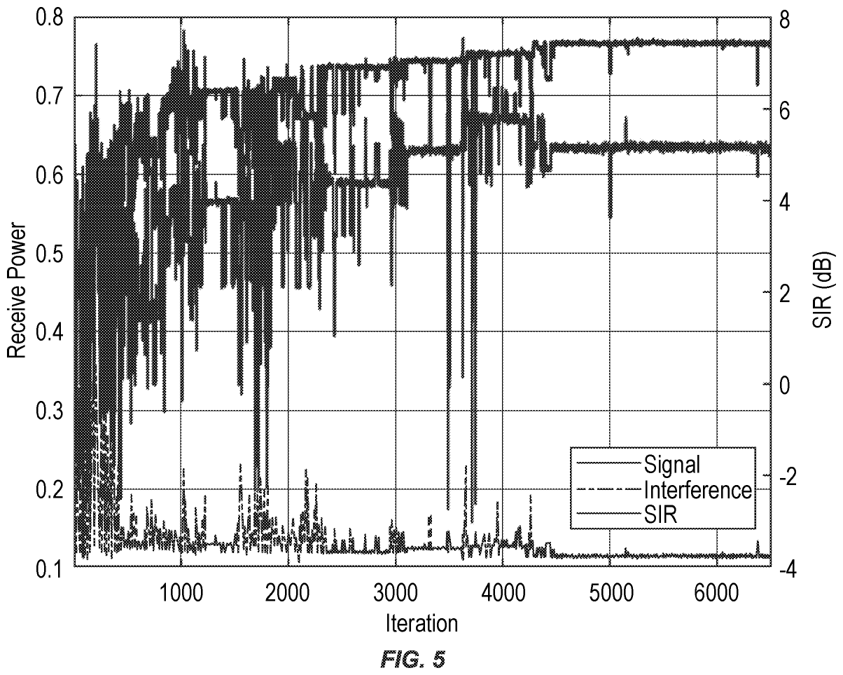

FIG. 3A is an image illustrating an exemplary prototype setup of the interference-aware beam pattern learning system. FIG. 3B is an image illustrating a top view of the prototype setup of FIG. 3A. FIGS. 3A and 3B show a desired signal source as well as an interference source, both transmitting signals at the same time-frequency slot in an omni-directional way. The prototyping setup further includes a receiver (a phased array with 16 antennas) trying to communicate with the signal source. The beam pattern learning happens at the receiver side where the objective is to form a receive beam pattern that produces the highest possible SINR, i.e., the same objective as in Equation 5.

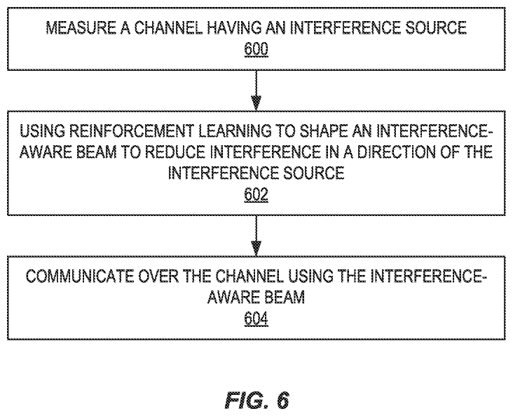

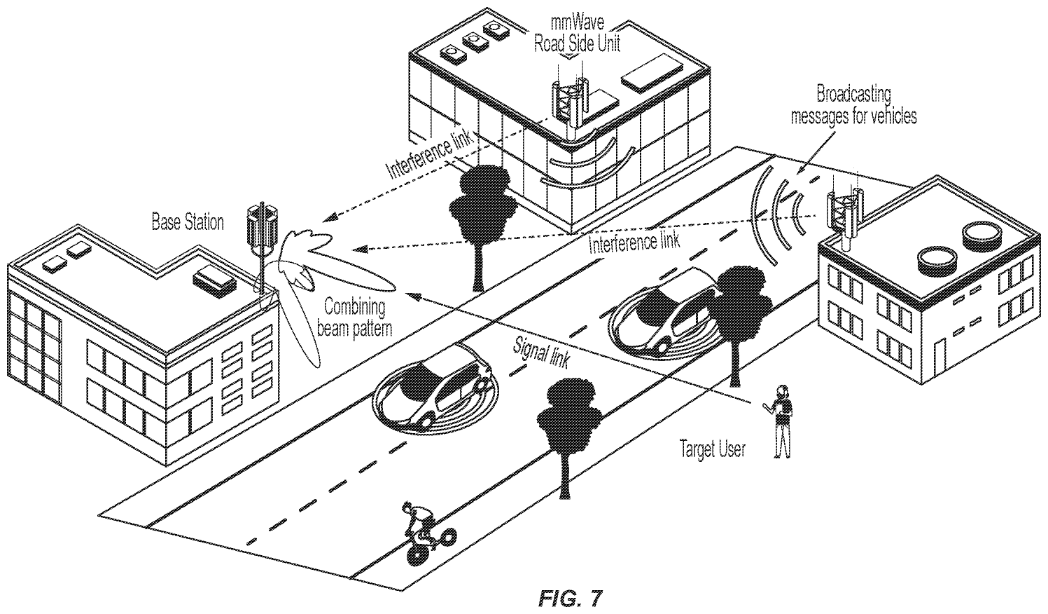

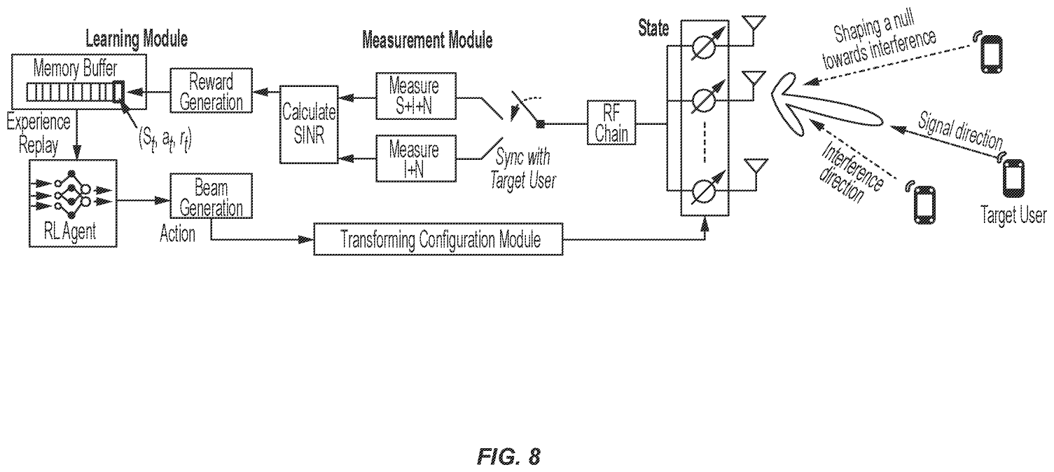

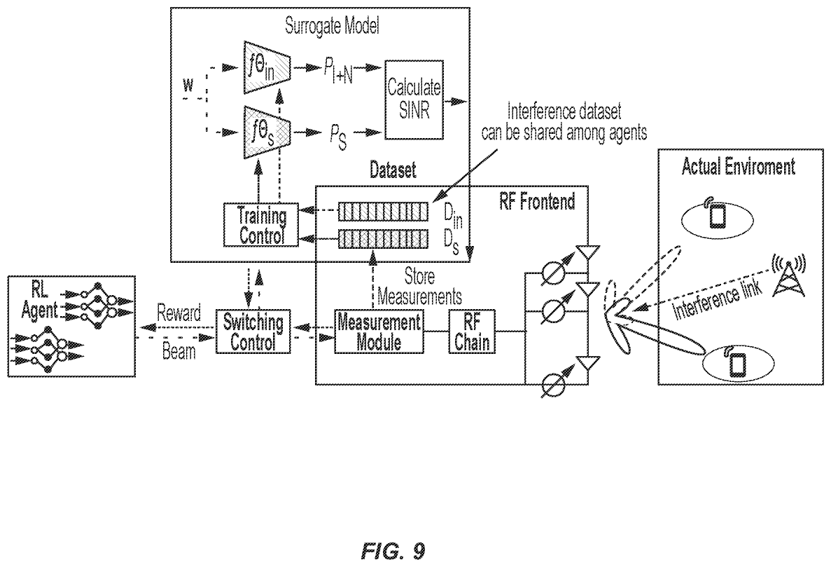

FIG. 4A is a graphical representation of receive power measurements with the transmitter and interferer of FIG. 3A off. FIG. 4B is a graphical representation of receive power measurements with the transmitter on and the interferer off. FIG. 4C is a graphical representation of receive power measurements with the transmitter off and the interferer on. FIG. 4D is a graphical representation of receive power measurements with the transmitter and the interferer on.

FIGS. 4A-4D show the receive power measurements of the default beamsteering codebook at the receiver under four different cases, i.e., different on/off status of signal source and interference source. As can be seen, there are 64 directional beams in the default codebook and the beam 33 produces the highest receive power (0.5689) of the desired signal. However, it also incurs very strong interference (0.2856). The beam in the default codebook that achieves the highest SIR (5.1 dB) is actually beam 31, which has a receive power of 0.5392 and interference power 0.1666.

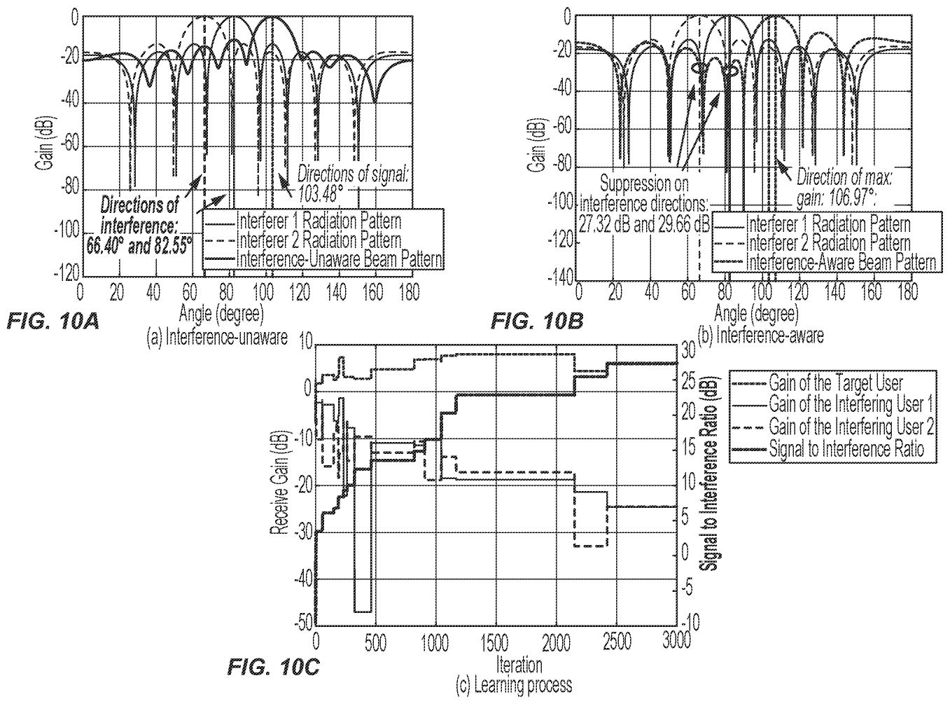

FIG. 5 is a graphical representation of signal power, interference power, and SIR as a function of iteration. FIG. 5 plots the real time performance of the disclosed interference-aware beam pattern learning algorithm. As can be seen, with around 4000 iterations, the learned beam gradually saturates at a level with signal power of 0.6243 and interference power of 0.1099, both outperforming the beam 31 in the default codebook, which gives an SIR of 7.55 dB.

### VII. Process for Designing an Interference-Aware Beam Pattern

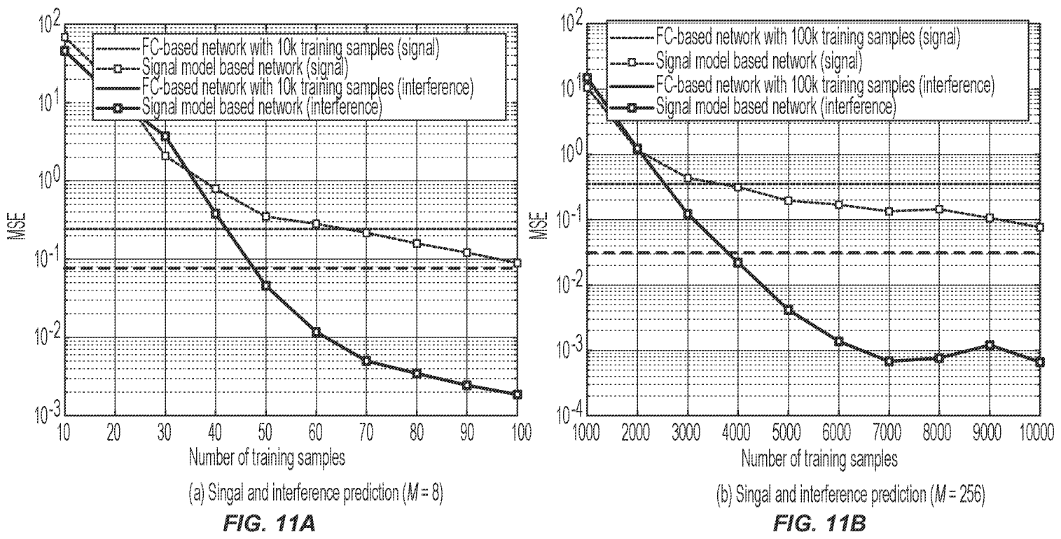

FIG. 6 is a flow diagram illustrating a process for designing an interference-aware beam pattern. The process begins at operation 600, with measuring a channel having an interference source. The process continues at operation 602, with using reinforcement learning to shape an interference-aware beam to reduce interference in a direction of the interference source. The process continues at operation 604, with communicating over the channel using the interference-aware beam.

Although the operations of FIG. 6 are illustrated in a series, this is for illustrative purposes and the operations are not necessarily order dependent. Some operations may be performed in a different order than that presented. Further, processes within the scope of this disclosure may include fewer or more steps than those illustrated in FIG. 6.

VIII. Online Beam Learning with Interference Nulling for Millimeter Wave MIMO Systems

Employing large antenna arrays is a key characteristic of millimeter wave (mmWave) and terahertz communication systems. Due to the hardware constraints and the lack of channel knowledge, codebook-based beamforming/combining is normally adopted to achieve the desired array gain. However, most of the existing codebooks focus only on improving the gain of their target user, without taking interference into account. This can incur critical performance degradation in dense networks. In this paper, we disclose a sample-efficient online reinforcement learning based beam pattern design algorithm that learns how to shape the beam pattern to null the interfering directions. The disclosed approach does not require any explicit channel knowledge or any coordination with the interferers. Simulation results show that the developed solution is capable of learning well-shaped beam patterns that significantly suppress the interference while sacrificing tolerable beamforming/combing gain from the desired user. Furthermore, a hardware platform based on mmWave phased arrays is built and used to implement and evaluate the developed online beam learning solutions in realistic scenarios. The learned beam patterns, measured in an anechoic chamber, show the performance gains of the developed framework and highlight a machine learning based beam/codebook optimization direction for mmWave and terahertz systems.

Millimeter wave (mmWave) and terahertz (THz) communication systems need to employ large antenna arrays to combat the severe path-loss and achieve sufficient receive signal power. Given the high cost of the mixed-signal components, these systems rely mainly on fully-analog or hybrid analog-digital architectures with much smaller number of RF chains compared to the number of antennas [2]-[4]. These architectures, however, make it hard to explicitly estimate the wireless channels, which motivated these systems to rely on pre-defined beam codebooks for both initial access and data transmission [4]-[7]. Being pre-defined, however, those beams are normally designed in a way that focuses solely on improving the beamforming/combining gain from specific directions, without taking interference into account. This leads to sub-optimal performance in dense deployments or in scenarios with intended interference/jamming. This urges the research for advanced analog/hybrid beam design approaches that are interference aware. Realizing that, however, is challenging because (i) these beams need to be designed online in the filed and (ii) without explicit channel knowledge which is hard to acquire for analog/hybrid architectures (especially for the interfering transmitters). With this motivation, this paper focuses on developing a beam learning framework that is able to learn interference nulling beam patterns while respecting the hardware and system operation constraints.

### A. System and Channel Models

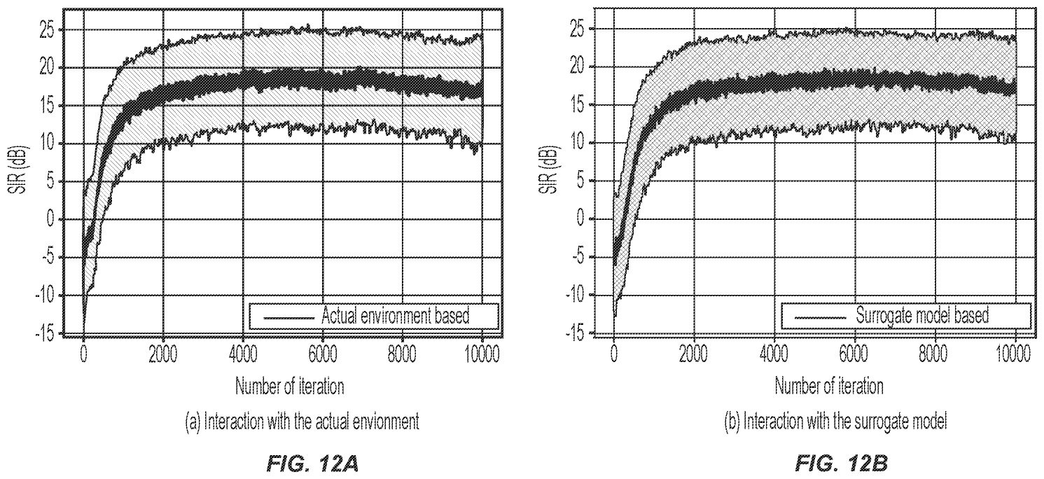

Our objective in this paper is to investigate the online design of interference-aware beam patterns, i.e., the online learning/design of beam patterns that achieve their original objectives while nulling the interference introduced by other sources in the environment. To study this problem, we consider the communication system in FIG. 7, where a mmWave MIMO base station (BS), equipped with M antennas, is communicating with a single-antenna user equipment (UE) in an uplink mode. Moreover, we assume that there exist K (>1) non-cooperative interference transmitters in the vicinity of the BS, operating at the same frequency bands and hence causing interference to the BS receiver. Therefore, if the UE transmits a symbol x ∈C to the BS, and the other K interference transmitters also transmit symbols xₖ ∈C, k=1, . . . , K at the same time and frequency slot, such that all the transmitted [symbol] symbols satisfy the same average power constraint, i.e., [symbol] [|x|²]=Pₓ and [symbol] [|xₖ|²]=P₂, ∀k, the received signal at the BS after combining can then be expressed as

$$y = {w}^{H} h x + {\sum }_{k = 1}^{K} {w}^{H} {h}_{k} {x}_{k} + {w}^{H} n \qquad Equation ( 9 )$$

where h ∈ [symbol] ^{M×1} is the channel between the BS and the UE, hₖ ∈ [symbol] ^{M×1} is the channel between the BS and the k-th interference transmitter. It is worth pointing out here that for clarity, we subsume the factors such as path-loss and transmission power into the channels. n˜ [symbol] (0, σ²I) is the receive noise vector at the BS with σ² being the noise power and w ∈ [symbol] ^{M×1} is the combining vector used by the BS. Furthermore, given the high cost and power consumption of the mixed-signal components, we consider a practical system where the BS has only one radio frequency (RF) chain and employs analog-only beamforming/combining using a network of r-bit quantized phase shifters. Therefore, the combining vector at the BS can be written as

$$w = {\frac{1}{\sqrt{M}} [ {e}^{j {θ}_{1}} , {e}^{j {θ}_{2}} , … , {e}^{j {θ}_{M}} ]}^{T} \qquad Equation ( 10 )$$

where each phase shift θₘ, ∀m=1, . . . , M is selected from a finite set ψ with 2^{r} possible discrete values drawn uniformly from (−π, π]. The normalization factor M^{-1/2} is to make sure the combiner has unit power, i.e.,

$${‖ w ‖}_{2}^{2} = 1 .$$

FIG. 7 shows the considered uplink scenario where a mmWave base station, operating in a receive mode, is communicating with its target user under the presence of non-cooperative interference transmitters. This could be the case, for instance, where the mmWave road side units of a vehicular network are broadcasting traffic messages to the surrounding vehicles, which interferes the civilian data communication link, as depicted in the figure.

It is noted that the RF precoder in a system with hybrid architecture is normally constructed using pre-defined codebooks that have pre-determined beams. Therefore, the learned beams in this paper can be included in such codebooks and be used in the hybrid analog/digital architectures as well.

We adopt a geometric channel model for the channel between BS and UE, as well as the interference channels between BS and any interfering transmitters. Hence, the channel between BS and its served UE takes the following form (the channel between BS and any interference transmitter takes similar form)

$$h = {\sum }_{ℓ = 1}^{L} {a}_{ℓ} a ( {ϕ}_{ℓ} , {ℓ}_{} ) \qquad Equation ( 11 )$$

where L is the number of multi-paths. Each path [symbol] has a complex gain [symbol] , which includes the path-loss. The angles [symbol] and [symbol] represent the [symbol] -th path's azimuth and elevation angles of arrival respectively, and a( [symbol] ) is the BS array response vector. The exact expression of a( [symbol] ) depends on the array geometry and possible hardware impairments.

### B. Problem Formulation

The design of the analog combining/precoding that achieves interference awareness (i.e., attempts to address the interference) is now described without explicitly knowing any channel state information. Given the receive signal (1) at the BS, the achievable rate of its target user can be written as

$$R = {log}_{2} ( 1 + \frac{{\vert {w}^{H} h \vert}^{2} {P}_{x}}{{\sum }_{k = 1}^{K} {\vert {w}^{H} {h}_{k} \vert}^{2} {P}_{x} + {σ}^{2}} ) \qquad Equation ( 12 )$$

The objective is to design the combining vector w such that the achievable rate of the target user, i.e., (12), can be maximized. Given the monotonicity of the logarithm function, this is equivalent to maximize the SINR term in (12). Therefore, the problem of designing interference-aware beam pattern can be cast as

$$\begin{matrix}{w}^{⋆} = {arg max}_{w} & \frac{{\vert {w}^{H} h \vert}^{2} {P}_{x}}{{\sum }_{k = 1}^{K} {\vert {w}^{H} {h}_{k} \vert}^{2} {P}_{x} + {σ}^{2}}\end{matrix} , \qquad Equations ( 13 ) - ( 15 )$$

$$\begin{matrix}s . t . & {w}_{m} = \frac{1}{\sqrt{M}} {e}^{j {θ}_{m}} , ∀ m = 1 , … , M\end{matrix}$$

$${θ}_{m} ∈ ψ , ∀ m = 1 , … , M ,$$

where wₘ is the n-th element of the combining vector w. The interference-aware beam pattern design problem formulated in (13) has the following challenges: (i) The constraint (14) requires constant-modulus on all the elements of the combining vector, which is a non-convex constraint, (ii) to respect the discrete phase shifter hardware constraint, w, can only take finite number of values based on all the possible phase shifts given by (15), (iii) the target UE's channel h is assumed to be unknown, since it is hard to acquire the CSI in practice, especially with analog/hybrid architectures, (iv) the channels of the interfering transmitters, i.e., hₖ∀k, are also unknown, since there is normally no coordination with the interfering transmitters, and (v) the possible hardware impairments are also assumed to be unknown.

Given these aforementioned difficulties, it is hard to solve (13) using the conventional optimization methods [11], [29], [30]. An observation, however, is that for a given combining beam w, evaluating the SINR requires only the power values (after combining) of the desired and interference signals, and does not require explicit knowledge about the channel vectors. Fortunately, it is less hard and more robust to acquire the receive power measurements for both the desired and interference signals, which requires much less training/signaling overhead and more relaxed synchronization constraints compared to the channel estimation process. With this observation, we cast our problem as developing an online machine learning approach that learns how to design an interference-aware beam pattern w that optimizes (13), given only the receive power measurements for the signal plus interference and noise,

$${\vert {w}^{H} h \vert}^{2} {P}_{x} + {\sum }_{k = 1}^{K} {\vert {w}^{H} {h}_{k} \vert}^{2} {P}_{x} + {σ}^{2} ,$$

and the interference plus noise,

$${\sum }_{k = 1}^{K} {\vert {w}^{H} {h}_{k} \vert}^{2} {P}_{x} + {σ}^{2} .$$

In the next section, we provide a detailed description of the disclosed solution for tackling the beam learning optimization problem in (13). Then, in Section D, we introduce a surrogate model assisted learning approach which achieves better sample efficiency as well as enhances the deployment flexibility of the disclosed interference-aware beam learning framework.

### C. Online Learning of Interference Aware Beam Pattern Design

In this section, we present the disclosed online reinforcement learning based interference aware beam pattern learning approach. The motivation of using reinforcement learning is twofold: First, the lack of the explicit channel knowledge renders most of the existing beamforming design approaches, such as [6], [31], infeasible. Second, the beam design problem is essentially a search problem over a very huge space. Hence, we consider leveraging the powerful exploration capability of reinforcement learning to efficiently navigate through this large space to find the optimal or near-optimal beam patterns. Next, we first discuss the disclosed system operation in Section C-i. Then, we provide the details of the disclosed solution in Section C-ii.

It is noted that the disclosed interference-aware beam learning approach can be straightforwardly extended to learning a codebook with multiple beams by, for example, using the user clustering and assignment algorithm disclosed in [5].

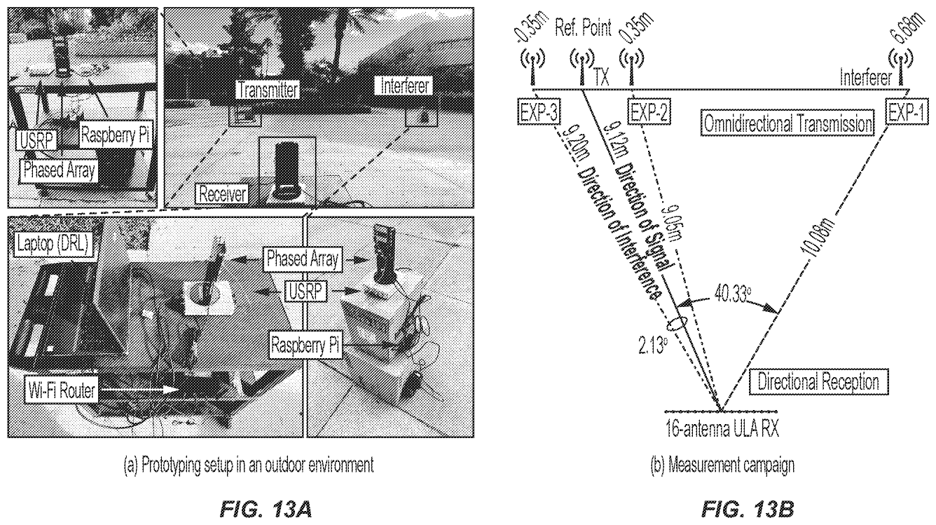

FIG. 8 shows an illustration of the operation flow of the disclosed interference-aware beam pattern learning solution, where the signal power is estimated by configuring the desired UE to transmit the signal in an on/off fashion.

i. Practical System Operation

In this subsection, we discuss how to acquire the power measurements that are used for evaluating the objective function of the formulated beam design optimization problem (13), which will also be used in the disclosed beam learning approach. As will be discussed in Section C-ii, the disclosed beam learning solution relies only on the power measurements in its operation. In particular, it needs to measure the power of the received signal from the target user as well as the interference power incurred from the other undesired transmitters. Given that the BS can coordinate with its served UE to know when it is transmitting, this knowledge could be leveraged to enable the required power measurements. To be more specific, to estimate the SINR performance of a certain beam \tilde{w}, the BS first measures the interference plus noise level, i.e.,

$${P}_{I + N} = {\sum }_{k = 1}^{K} {\vert {\tilde{w}}^{H} {h}_{k} \vert}^{2} {P}_{x} + {σ}^{2} ,$$

when the target UE is not transmitting. Then, when the target UE starts transmitting reference signals, the BS uses the same beam to measure the signal plus interference plus noise level, i.e.,

$${P}_{S + I + N} = {\vert {\tilde{w}}^{H} h \vert}^{2} {P}_{x} + {\sum }_{k = 1}^{K} {\vert {\tilde{w}}^{H} {h}_{k} \vert}^{2} {P}_{x} + {σ}^{2} .$$

The receive power of the target UE can hence be determined by subtracting the previously measured power P_{I+N} from the new power measurement P_{S+I+N}, and the SINR can be approximately obtained as (P_{S+I+N}−P_{I+N})=P_{I+N}. To this end, it is worth mentioning that, in practice, zero power reference signals, such as the Sounding Reference Signal (SRS) that is not scheduled for any UE in the 5G NR, could be potentially leveraged to measure the interference plus noise level [32], i.e., P_{I+N}.

In the next subsection, we present the basic idea of the disclosed online reinforcement learning approach for learning interference-aware beams based solely on these power measurements.

ii. Reinforcement Learning Based Interference Aware Beam Pattern Design

Given the system operation in Section IV-A, we now describe our disclosed reinforcement learning based solution for addressing the interference-aware beam pattern design problem (13). To do that, we first formulate our beam design problem as a reinforcement learning problem. Then, we present the disclosed deep reinforcement learning architecture for solving this problem. Reinforcement Learning Formulation: To solve the problem with reinforcement learning, we first fit all the ingredients of problem (13) into a general reinforcement learning framework as follows (as also illustrated in FIG. 8):

State: We define the state sₜ as a vector that consists of the phases of all the phase shifters at the t-th iteration, that is, sₜ=[θ₁, θ₂, . . . , θ_{M}]^{T}. This phase vector can be converted to the actual combining vector w by applying (10). Since all the phases in sₜ are selected from ψ, and all the phase values in ψ are within (−π; π], (10) essentially defines a bijective mapping from the phase vector to the combining vector. In this paper, we will use the term “combining phase vector” to refer to this phase vector and use the term “combining vector” to refer to the actual combining vector.

Action: We define the action aₜ as the element-wise changes to all the phases in sᵢ. Since the phases can only take values in ψ, a change of a phase represents the action that a phase shifter selects a value from ψ. Therefore, the action is directly specified as the next state, i.e., aₜ=sₜ+1, which can be viewed as a deterministic transition in the Markov Decision Process (MDP).

Reward: We define a binary reward mechanism, i.e., the reward rᵢ takes values from {+1, −1}. Since the objective of (13) is to maximize the SINR performance, we compare the SINR achieved by the current combining vector, denoted as SINRₜ, with the previous one, i.e., SINRₜ₋₁. The reward is determined according to the following rule: rᵢ=+1, if SINRₜ>SINRₜ₋₁; rᵢ=−1, otherwise.

It is worth highlighting that the above reinforcement learning formulation is fully compatible with the original problem (13) in the following aspects. First, since the state and action are directly specified as phase shifts of the discrete analog phase shifters, the constraints (14) and (15) are automatically satisfied. Second, to obtain the reward, the objective function of (13), i.e., the SINR performance, needs to be evaluated, which can be done in a way that does not rely on the channel state information of both the target user and the interfering transmitters, the details of which has been provided in Section C-i.

Deep Reinforcement Learning Architecture: Given the reinforcement learning formulation above for the interference-aware beam learning problem, we adopt an actor-critic based deep reinforcement learning architecture. This follows the learning framework that we disclosed earlier in [5]. In summary, both the actor and critic networks are implemented using elegant fully connected (FC) feed-forward neural networks. The input of the actor network is the state and the output is the action, while the critic network takes in the state-action pair and outputs the predicted Q value. Moreover, to respect the discrete phase shifter hardware constraint (15), we perform an element-wise quantization to make the predicted action a valid one. To be more specific, assume that [symbol] is the predicted action from the actor network at time t. Then, the action that finally gets implemented to the system is given by

$${[ {a}_{t} ]}_{m} = {arg min}_{θ ∈ Ψ} \vert {[ {\hat{a}}_{t} ]}_{m} - θ \vert , ∀ m = 1 , … , M \qquad Equation ( 16 )$$

It is worth emphasizing that such quantization operation is only activated when the system is actually implementing the predicted action by the actor network to obtain reward. It is not involved in the training process of the actor network due to its non-differentiability.

Despite its full compatibility with the considered system as well as the 3GPP standards [32], the disclosed interference-aware beam learning solution still has two drawbacks. First, it requires a relatively large number of iterations to find a qualified beam pattern, especially when the number of antennas is large. As a result, this incurs a large beam learning overhead, since these iterations are done over the air. Second, as indicated by the objective function of (13), the SINR performance of a given beam is determined by two factors: (i) The desired beamforming gain and (ii) The effectiveness of suppressing the undesired interference. However, the disclosed solution does not fully leverage this information as it only focuses on the overall SINR performance. It turns out that the decomposition of these two factors, as will be further discussed in the next section, makes the data sharing among the learning processes of different beams possible, which has the potential of improving the convergence behavior of the beam/codebook learning algorithm. With this motivation in mind, in the next section, we introduce a modified learning framework which includes a surrogate model that assists the beam learning process. The adopted surrogate model better utilizes the underlying signal model and hence the sample efficiency (a measure for the number of real measurements) is further improved. It also provides more deployment flexibility and enables other features such as data sharing. The detailed architectures and the parameters of the adopted neural networks are provided in Section E-ii.

### D. Surrogate Model Assisted Beam Learning Framework

In this section, we describe in detail the disclosed surrogate model assisted interference aware beam pattern learning framework. The motivations of introducing the surrogate model are mainly two-folds. First, it has the potential of improving the sample efficiency (i.e., reducing the number of interactions with the actual environment) of the learning process by leveraging the underlying signal models. Second, it facilitates other more complex tasks (than learning a single beamforming vector), such as data sharing (which can be very useful in learning interference aware beam codebook) and cooperative learning (among multiple BSs to avoid interfering each other). The overall objective is to have a simulated environment that can provide the DRL agents with authentic feedback as if the agents are interacting with the actual environment. Next, we first introduce the adopted surrogate model in Section D-i. Then, we provide more details about how to integrate the surrogate model with the RL beam learning algorithm in Section D-ii. Finally, we discuss several practical aspects of the learning framework in Section D-iii.

i. Surrogate Model for Beam Pattern Learning

In this subsection, we introduce the disclosed surrogate model that assists the learning of interference-aware beams. As can be seen from Section C-i, in order to acquire the reward signal that is used for training the RL agent, the system needs to estimate two quantities, i.e., the signal power, Pₛ=|w^{H}h|²Pₓ, and the interference plus noise power,

$${P}_{I + N} = {\sum }_{k = 1}^{K} {\vert {w}^{H} {h}_{k} \vert}^{2} {P}_{x} + {σ}^{2} .$$

Therefore, correspondingly, there are two major components in the considered surrogate model that provide the agent with such information, i.e., an interference predictor and a signal predictor, as will be discussed in this subsection.

For instance, as the system has full knowledge of its simulated environment, it can assign accurate reward to each agent. This has the potential of mitigating the non-stationary environment problem that exists in most of the multi-agent learning tasks.

1) The key idea of surrogate model: The machine learning model that virtually interacts with the agent can be considered as a surrogate model. This model is used to imitate the behavior of the actual environment, aiming to reduce the expensive (sometimes, even impossible) actual evaluations of the design. In this paper, we design the surrogate model with a particular emphasis on two aspects:

Prediction accuracy: As the name suggests, a surrogate model is essentially a prediction model which imitates (or predicts) the behavior (or response) of an unknown environment to a certain input action. Hence, being accurate is a property of the considered surrogate model.

Data requirement: Another property of a surrogate model, in the considered interference-aware beam learning task, is data requirement. This refers to the amount of data that is required by the surrogate model for the training purposes, in order to reach a certain prediction accuracy constraint. Generally speaking, a surrogate model is more valuable if it requires less data to achieve a satisfactory performance. With these criterions in mind, we next describe the adopted surrogate model. As mentioned before, the considered surrogate model consists of two major components, i.e., an interference prediction model and a signal prediction model. Formally, the interference prediction model predicts the interference plus noise power based on the configuration of the receive combining vector, which can be expressed as

$${\hat{P}}_{I + N} = {f}_{i n} ( w ; {Θ}_{i n} ) \qquad Equation ( 17 )$$

where w ∈ [symbol] ^{M×1} is the input of the model, representing the designed receive combining vector, and the output is the predicted interference plus noise power, i.e., P_{I+N} ∈ [symbol] The model is parameterized by Θᵢₙ. Similarly, the signal prediction model predicts the signal power of a given receive combining vector, which can be written as

$${\hat{P}}_{S} = {f}_{s} ( w ; {Θ}_{s} ) \qquad Equation ( 18 )$$

where Pₛ ∈ [symbol] is the predicted signal power value and Θₛ denotes the model parameters. It is worth mentioning that the architecture of fᵢₙ and fₛ is not unique and is a design choice.

Next, we present two candidates that could be used in the considered beam learning task.

2) Surrogate model architecture: As mentioned before, the choice of fᵢₙ and fₛ is not unique. In this paper, we study two specific designs: (i) A model-based prediction architecture, and (ii) a fully-connected neural network based prediction architecture.

Model-based architecture: The model-based architecture, as its name suggests, is inspired by the underlying signal model. For instance, as can be seen from the expression of the interference plus noise power, i.e.,

$${P}_{I + N} = {\sum }_{k = 1}^{K} {\vert {w}^{H} {h}_{k} \vert}^{2} {P}_{x} + {σ}^{2} ,$$

it takes a quadratic form of the receive combining vector w. To see this, by defining H=[h₁, h₂, . . . , h_{K}], P_{I+N} can be expressed as

$$\begin{matrix}{P}_{I + N} = {‖ {H}^{H} w ‖}_{2}^{2} {P}_{x} + {σ}^{2} , \\ = {w}^{H} ( {P}_{x} {HH}^{H} + {σ}^{2} I ) w , \\ = {w}^{H} Aw ,\end{matrix} \qquad Equations ( 19 ) - ( 21 )$$

where A=PₓHH^{H}+σ²I. The signal power can be expressed in the similar form, i.e., P_{S}=w^{H}Pₓhh^{H}w. Therefore, the interference prediction network is essentially leveraged to learn the relationship (21). Inspired by this, we design the interference prediction network with a focus on imitating the “behavior” of A. Specifically, the interference prediction network is chosen to take the following form

$${f}_{i n} ( w ) = {w}^{H} {Q}_{i n} {Q}_{i n}^{H} w \qquad Equation ( 22 )$$

where Qᵢₙ ∈ [symbol] ^{M×r}^{ᵢₙ} with rᵢₙ being a hyperparameter. Therefore, the parameter of the interference prediction network is essentially Qᵢₙ, i.e., Oᵢₙ={Qᵢₙ}. The signal prediction network takes the similar form, i.e.,

$${f}_{s} ( w ) = {w}^{H} {Q}_{s} {Q}_{s}^{H} w ,$$

where Q_{S} ∈ [symbol] ^{M×r}^{ₛ} with rₛ being a hyperparameter as well, which makes Θₛ={Qs}.

Fully-connected neural network based architecture: Despite being lightweight and a better fit to the signal model, the model-based architecture, fundamentally, suffers from any mismatch between the assumed signal model and the actual signal relationship. For instance, there are normally unknown non-linearities in the practical hardware that undermine the validity of the assumed relationship between the receive combining vector and the interference plus noise power (similarly for the signal power). As a result, the signal model cannot always be met and the model-based architecture will show up certain level of residual prediction errors that are very hard to be eliminated given the less powerful expressive capability of its architecture. Motivated by this, we also investigate a more general architecture, which is built upon fully-connected neural network, given its powerful universal approximation capability [33]. Specifically, both fᵢₙ and fₛ are modeled with feed-forward fully-connected neural networks. The detailed network parameters will be provided in Section E-ii.

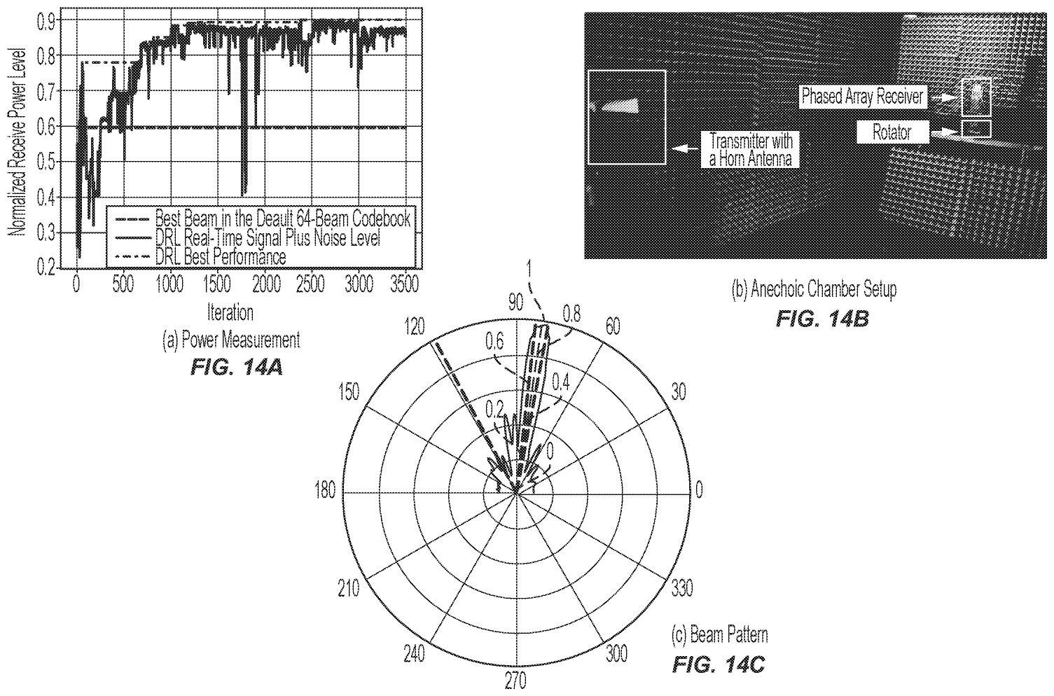

FIG. 9 shows an illustration of the disclosed surrogate model assisted interference-aware beam pattern learning framework.

3) Training dataset and loss function: We denote the dataset used for training the interference prediction network as

$${𝒟}_{in} = \{ {( {w}^{( n )} , {P}_{I + N}^{( n )} )}_{n = 1}^{{N}_{in}} \} \qquad Equation ( 23 )$$

where each data sample is comprised of a combining vector and its corresponding interference plus noise power value obtained from the actual environment, i.e., from the real measurement. Nᵢₙ is the total number of data samples in the dataset, i.e., | [symbol] ᵢₙ=Nᵢₙ|. And the dataset used for training the signal prediction network can be similarly denoted as

$${𝒟}_{s} = \{ {( {w}^{( n )} , {P}_{S}^{( n )} )}_{n = 1}^{{N}_{s}} \} \qquad Equation ( 24 )$$

with Nₛ being its size. We will discuss how to efficiently collect these datasets in Section D-iii.

Since the target of these two networks is to predict the power values, we pose the learning problem as a regression problem conducted in a supervised fashion. Furthermore, we employ mean squared error (MSE) as the training loss function. Using the interference prediction network as an example, for the n-th data sample in Dᵢₙ, the loss function is defined as

$$\begin{matrix}ℒ ( {P}_{I + N}^{( n )} , {\hat{P}}_{I + N}^{( n )} ) = {\vert {P}_{I + N}^{( n )} - {\hat{P}}_{I + N}^{( n )} \vert}^{2} , \\ = {\vert {P}_{I + N}^{( n )} - {f}_{i n} ( {w}^{( n )} ; {Θ}_{in} ) \vert}^{2} .\end{matrix} \qquad Equation s ( 25 ) - ( 26 )$$

The loss function used for the signal prediction network is identical.
ii. Surrogate Model Assisted Learning

In this subsection, we discuss how to integrate the surrogate model with the disclosed RL based beam learning framework. Since the surrogate model is essentially used to provide the RL agent with a simulated environment to interact with, it plays the same role as the actual environment. However, in order to provide high quality synthetic feedback, it requires training process that relies on the authentic data collected from the actual environment. Based on the trained surrogate model, the system can virtually evaluate its designed beams without measuring the physical signals. Moreover, the system might require constantly switching between the surrogate model and the actual environment, triggered by the demand for the authentic data. Next, we summarize the key components of the disclosed surrogate model assisted beam learning.

1) Initial interaction and data acquisition: The system starts with the normal interaction between the RL agent and the actual environment. To be more specific, upon forming a new beam i, the BS follows the procedures presented in Section C-i to estimate the interference plus noise power P_{1+N} and the signal power Pₛ. The reward signal used for RL agent learning will then be generated. Moreover, these authentic power measurements together with the beam will be stored in the two datasets, i.e., [symbol] ᵢₙ and [symbol] ₛ, respectively. During this interaction process, two initial datasets are established.

2) Surrogate model training: Based on the collected initial datasets Dᵢₙ and Dₛ, the two sub-networks of the surrogate model, i.e., the interference prediction network fᵢₙ and the signal prediction network fₛ, are trained in a supervised manner. After the training process saturates, the surrogate model is ready to interact with the RL agent.

3) Environment switching and virtual interaction: The switching from the actual environment to the surrogate model is triggered based on multiple factors, which will be discussed in detail in Section D-iii. As a result, after the switching is finished, the reward signal required by the RL agent will be provided by the trained surrogate model instead of the actual environment. The agent keeps interacting with the surrogate model until it does not improve, which marks the saturation of the agent learning and the end of the virtual interaction process.

4) Demand based switching and active data acquisition: The system might require executing the above steps multiple times, based on the achieved performance. The motivation of such repetition can be summarized as follows. From the model training perspective, the quality of the collected datasets, i.e., [symbol] ᵢₙ and [symbol] ₛ, has significant influence on the prediction accuracy of the trained surrogate model. To be more specific, during the initial interaction process, most of the beams tried out by the agent are relatively random and hence have relatively poor quality in terms of SINR performance. This means that the datasets are, intuitively speaking, biased towards the “poor-quality” beams. As a result, the trained surrogate model will have relatively inaccurate predictions on the beams that actually have better performance. The incurred residual prediction error will in turn influence the learning of the agent, leading to unsatisfactory performance.

However, as the policy of the RL agent gets improved over time, the actions performed by the agent, i.e., the beams, are more likely to be in the beam space where the achieved SINR is high. Therefore, it is advisable to switching back to the actual environment to re-collect data (through agent-environment interaction). Such active data acquisition can enhance the training datasets with “high-quality” beams. Using those better data samples to refine the parameters of the surrogate model can help achieve higher prediction accuracy in the interested beam space, which further helps the learning of the agent. By alternatingly performing these steps, the system has higher chance to collect data samples that are more useful for the agent learning, which has the potential of further enhancing both sample efficiency and learning convergence. We show such interplay between the RL agent, actual environment and the surrogate model in FIG. 9.

iii. Practical Considerations

In this subsection, we discuss some practical considerations of the disclosed surrogate model assisted interference-aware beam pattern learning solution.

1) Dataset collection: An observation is that for any given beam, its achieved signal power remains the same regardless of the presence of the interference signals. This implies that the interference power dataset [symbol] ᵢₙ and the signal power dataset [symbol] ₛ, i.e., (23) and (24), can be collected in a “non-synchronized” way, which facilitates the data collection in few cases. For instance, on one hand, if the interference transmitters are not transmitting signals, the system can only collect data samples and store them into [symbol] ₛ. In this case, the interference plus noise power P_{1+N} becomes the noise power P_{N}, and the signal power can be measured in a similar fashion. On the other hand, if the interference happens aperiodically and sparse, the system can be dedicated to measure P_{1+N} whenever the interferers are present, i.e., without measuring the signal power during this period.

2) Data sharing: The aforementioned non-synchronized measurement strategy also implies that data sharing is possible. To be more specific, if the interference transmitters are fixed, the collected interference dataset Dᵢₙ can be reused for different target UEs. This has the potential of accelerating the learning process as well as reducing the memory requirement (i.e., to store the measurement dataset). It is also particularly interesting when learning a codebook.

3) Switching trigger: Another problem is how to design the conditions that control the switching between the surrogate model and the actual environment. Although such criterion is a design choice and is normally determined by a variety of factors, it would be beneficial if the design can somehow reflect the intentions of introducing a surrogate model, which are: (i) To support the continuous learning (when the actual environment cannot provide immediate feedback), and (ii) to reduce the expensive evaluations. For instance, it is reasonable to switch to the actual environment when the training processes of both the surrogate model and the RL agent saturate. However, when the surrogate model can provide very accurate predictions, the switching should be avoided to reduce the unnecessary overhead.

4) Parallel computing: It is also possible to perform the training of the surrogate model and the learning of the agent at the same time. This can be done, for instance, by duplicating the surrogate model, where one of the duplicates (with its parameters being frozen) will be used to interact with the RL agent. The other is trained with the up-to-date datasets, and after the training finishes, its parameters can be used to update the one that is interacting with the RL agent. This implies that the second and third steps mentioned in the previous subsection can be executed in parallel, which can help improve the convergence of the disclosed solution.

5) Quantized measurements: The disclosed surrogate model also supports the cases when the measurements are quantized. In such case, the output layer of both interference prediction network and signal prediction network can be modified to be a classification layer.

### E. Simulation Results

In this section, we numerically evaluate the performance of the disclosed reinforcement learning based interference-aware beam pattern design approach. We will first describe the adopted simulation setup in Section E-i. Then, in Section E-ii, we provide more details about the adopted architectures of the deep learning models as well as the training procedures. Finally, in Section E-iii, we present the numerical results of the disclosed solutions.

i. Simulation Setup

In this simulation, we consider the case where a BS receiver adopts uniform linear array (ULA) with half-wavelength antenna spacing. Each antenna of the ULA is followed by a 3-bit analog phase shifter. Besides, for a better demonstration, we adopt the following simulation steps: (i) We generate the channel of the target user based on (13), where, for simplicity, we consider the case when the user only has a line-of-sight (LOS) connection with the BS, i.e., L=1 in (13); (ii) We then learn a beam pattern assuming there is no interference and this learned beam is referred to as “interference-unaware” beam, since it solely focuses on maximizing the combining gain of the desired signal; (iii) After this beam is learned, we intentionally position the interfering transmitters at the directions aligning with the strongest side lobes of the learned beam and also assume that they only have LOS channels with the considered BS, which causes non-negligible interference; and (iv) We finally take the interference into account and re-design an “interference-aware” beam that learns how to manage the interference in such a way that improves the SINR performance.

ii. Deep Learning Models and Training Procedures

In this subsection, we provide more details about the adopted deep learning architectures for both the DRL agent and the surrogate model. We also provide the parameters regarding the training processes of these models.

1) DRL agent architecture: Since the input of the actor network is the state and the output is the action, the size of both the input and output of the actor network is M, i.e., the number of antennas. The critic network takes in the state-action pair and outputs the predicted Q value and hence it has an input size of 2M and an output size of 1. Both the actor and critic networks have two hidden layers in our disclosed architecture, with the size of the first hidden layer being 16 times of the input size and the size of the second hidden layer being 16 times of the output size in both networks. All the hidden layers are followed by the batch normalization layer for an efficient training experience and the Rectified Linear Unit (ReLU) activation layer. The output layer of the actor network is followed by a Tanh activation layer scaled by π to make sure that the predicted phases are within (−π, π] interval. The output layer of the critic network is a linear layer. Moreover, it is worth mentioning that we adopt the same DRL architecture for both solutions, regardless of having surrogate model or not.

2) Surrogate model architecture: We describe the two different architectures of the surrogate model studied in this paper. Also, as the signal prediction network and the interference prediction network have identical architecture in both solutions (i.e., model-based solution and fully connected neural network-based solution), for brevity, we only use the interference prediction network as an example.

TABLE 1
Hyper-Parameters for Surrogate Model Training

| Parameter | Model-Based | FC-Based |
|---|---|---|
| Batch size | 512 | 512 |
| Number of epochs | 500 | 500 |
| Optimizer | Adam | Adam |
| Initial Learning Rate | 1 × 10⁻¹ | 1 × 10⁻² |
| Learning Rate Schedule | 0.1@[50, 300, 400] | 0.1@[100, 300, 400] |

Signal model-based prediction network: As mentioned before in (22), the interference prediction network is essentially devised to take a quadratic form of the combining vector determined by a positive semi-definite matrix QᵢₙQᵢₙ^{H}, leaving the matrix [symbol] ᵢₙ to be the model parameter. Moreover, [symbol] ᵢₙ has a shape of M×rᵢₙ with M being the number of antennas and rᵢₙ being a hyper-parameter. The choice of rᵢₙ is empirically guided by the following rules: (i) rᵢₙ should not be too large as it will increase the model complexity and hence the required amount of training data; (ii) rᵢₙ should not be too small as it will limit the expressive capability of the model, leading to unsatisfactory prediction accuracy.

Fully-connected neural network based prediction network: We adopt the fully-connected neural network with two hidden layers to be the interference prediction network. The input layer of the network has M neurons, which is equal to the number of antennas. The output layer of the network has only one neuron with linear activation. Both hidden layers have M′ neurons. Similar to rᵢₙ in the model-based architecture, the selection of M′ needs to strike a balance between model complexity and model expressive capability. Moreover, all the hidden layers are followed by the batch normalization layer and ReLU activation layer.

3) Training parameters: As mentioned before, the surrogate model is trained in a supervised fashion, based on the collected power datasets, i.e., Dᵢₙ and Dₛ. Moreover, the interference prediction network and the signal prediction network are independently trained. However, for the same type of surrogate model, i.e., either model-based or fully-connected neural network based, we adopt the same training parameters for interference and signal prediction networks. We summarize the detailed hyper-parameters used for training the surrogate models in Table I.

iii. Numerical Results

In this subsection, we provide the simulation results of the disclosed interference-aware beam learning solutions. Moreover, to better present the results, in Section E-iii1, we first evaluate the reinforcement learning based beam design solution disclosed in Section C that keeps interacting with the actual environment. This is to demonstrate the achieved performance by the disclosed beam learning algorithm without knowing the channel knowledge. Then, in Section E-iii2, we test the surrogate model assisted beam design framework disclosed in Section D, with a focus on evaluating the validity and efficacy of using surrogate model to reduce the beam learning overhead, as well as comparing different surrogate model architectures.

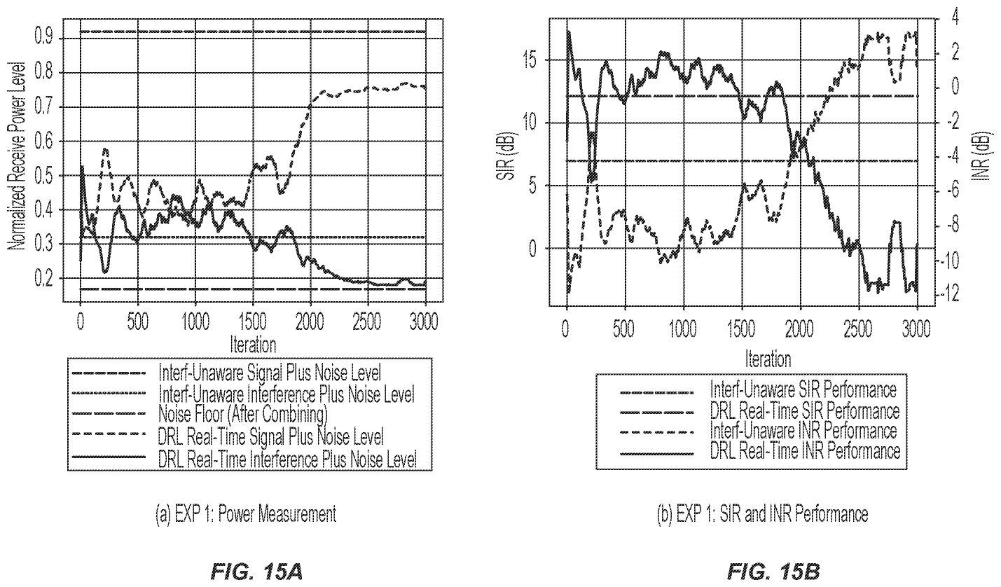

1) Interference nulling without knowing the channels: Based on the aforementioned simulation setup and deep learning architecture, in FIG. 10A, FIG. 10B, and FIG. 10C, we demonstrate the learning results when there are two interfering transmitters. We show the beam patterns learned with and without taking the interference into account, together with the receive patterns (i.e., the distribution of receive power strength in angular domain from the BS's perspective) of the selected interfering sources.

As shown in FIG. 10A, the two interferers are present at the directions aligning with the two most strongest side-lobes of the interference-unaware beam, which incurs significant interference and causes performance degradation. The learned interference-aware beam is plotted in FIG. 10B. As can be seen, the interference-aware beam shapes nulls that have very low receive gains at the directions of the interferers, which nearly eliminates the severe interference. To be more specific, in the interference-unaware case, the signal-to-interference ratio (SIR) levels are 10.56 dB and 13.71 dB with respect to the two interfering transmitters. By contrast, the SIR levels are improved to 28.63 dB and 26.28 dB when using the interference-aware beam, which only incurs a loss of 0.8348 dB for the combining gain of the target user.

In FIG. 10C, we show how the combining gains of the received signals from the target user and the interfering transmitters are changing as the learning proceeds, as well as the overall SIR performance. As can be seen, the combining gain of the target user and the combining gains of the two interfering transmitters start from almost the same level, since a random beam is used as the starting point. As learning proceeds, the combining gain of the target user maintains, generally speaking, an increasing trend, while the combining gains of the two interfering transmitters are gradually decreasing.

The overall SIR, however, maintains a monotonically increasing trend. Furthermore, as can be observed from the figure, the combining gain of the target user has a high spike (achieved by a certain learned beam) at the beginning of the learning process. However, despite the good performance on the target user, that beam also incurs strong interference from other undesired transmitters, hence resulting in an unsatisfactory SIR performance. Therefore, it is finally replaced by other beams that have slightly lower combining gain to the target user but are very effective in suppressing the interference. FIG. 10C also shows that with only around 1000 iterations, the SIR performance improved from around −10 dB to around 20 dB, without knowing the channels (for both the target user and the interfering transmitters).

FIG. 10A, FIG. 10B, FIG. 10C show the beam pattern learning results in an environment with two interfering transmitters, where (FIG. 10A) shows the learned beam pattern when ignoring the surrounding interfering transmitters, and (FIG. 10B) shows the interference-aware beam pattern. (FIG. 10C) shows the interference-aware beam pattern learning process.

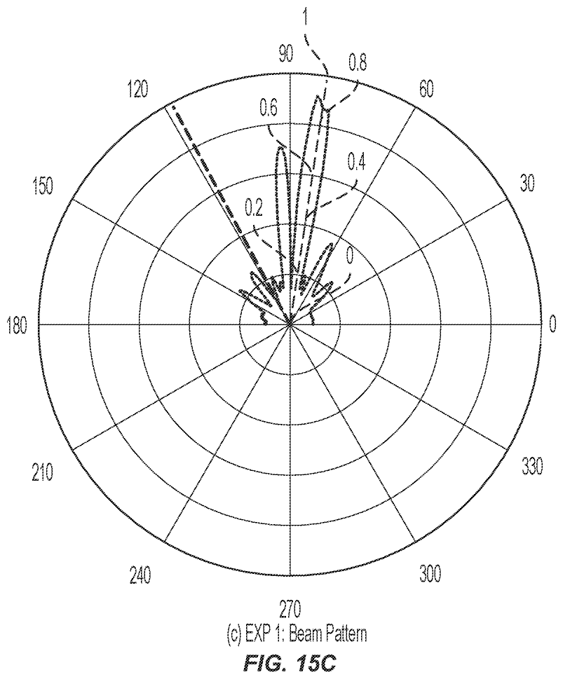

FIG. 11A and FIG. 11B show the prediction accuracy of different surrogate model architectures. It shows that the disclosed signal model-based prediction network requires much less data samples to outperform the FC-based prediction network in both cases, i.e., the base station equipping (FIG. 11A) M=8 antennas, and (FIG. 11B) M=256 antennas.

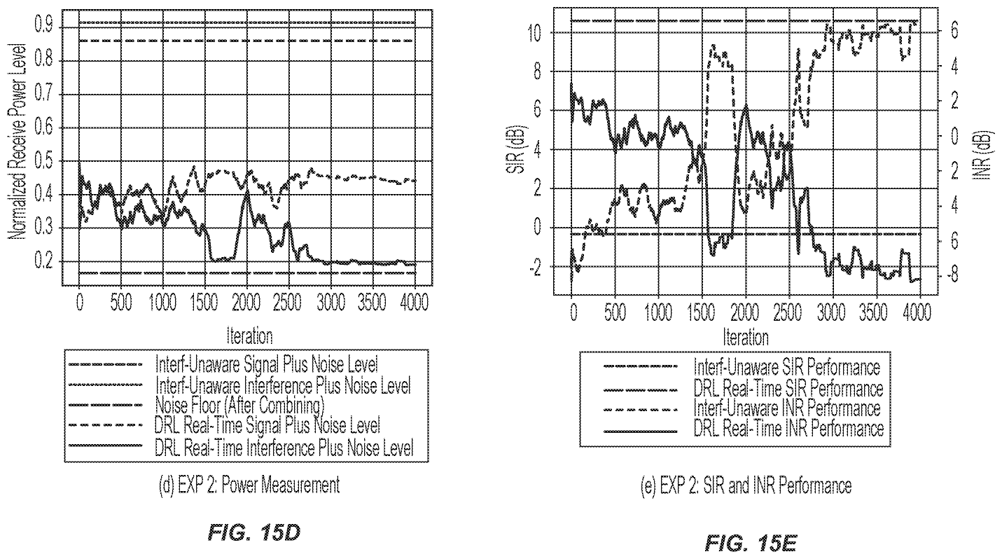

FIG. 12A and FIG. 12B show the learning experience of the DRL agent when interacting with (FIG. 12A) the actual environment and (FIG. 12B) the surrogate model trained with 1000 data samples.

2) Surrogate model assisted learning: We also evaluate the performance of the surrogate model assisted learning framework, which has the potential of significantly reducing the number of interactions with the actual environment.

In FIG. 11A and FIG. 11B, we first evaluate the prediction accuracy of the two disclosed prediction network architectures, which provides insight on how much data samples are required in order to have a reasonable performance as well as the practicality of the solutions.

We show the prediction accuracy of both the signal power and the interference power. As can be seen, the signal model-based architecture requires much less data samples to achieve higher prediction accuracy than the FC-based architecture trained with much more data samples. For instance, as indicated in FIG. 11A, with only 50 samples, the signal model-based prediction architecture can achieve even more accurate interference prediction than the FC-based architecture trained with 10,000 samples. This saves almost 99.5% of the measurements, yielding a more sample-efficient solution for the practical system deployment. Moreover, as there are more data samples, the prediction accuracy of the signal model-based architecture also gets improved quite significantly. Such performance is achieved by better leveraging the underlying signal relationships and hence the model parameters are essentially searched over a much smaller space. Finally, by comparing FIG. 11A and FIG. 11B, it can be observed that with more antennas, the system needs to collect more data samples to train the prediction networks in order to maintain the similar prediction accuracy when the number of antennas is small.

The trained surrogate model is utilized to interact with the DRL agent, aiming to reduce the expensive actual measurements conducted by the hardware. In FIG. 12A and FIG. 12B, we show the performance of the DRL agent when interacting with the actual environment as well as the surrogate model. The training of the DRL agent is repeated for 100 times and the average performance as well as the standard deviation are reported in FIG. 12A and FIG. 12B. We test the performance of a system with 8 antennas, and the surrogate model is trained using 1,000 data samples, i.e., | [symbol] ᵢₙ|=| [symbol] ₛ|=1000. As can be seen, the learning experience based on the surrogate model is quite similar to that of the one based on the actual environment. This empirically shows the effectiveness of using the surrogate model in training the DRL agent. As a result, although the DRL agent requires almost a total number of 5,000 interactions with the environment to converge, in the surrogate model assisted learning framework, all these interactions are with the surrogate model and hence the expensive evaluations on the real hardware are avoided.

### F. Real Measurement Results

In this section, we further evaluate the performance of the disclosed interference-aware beam pattern learning algorithm in Section C-ii using a real-world mmWave prototyping platform.

i. Hardware Platform Description

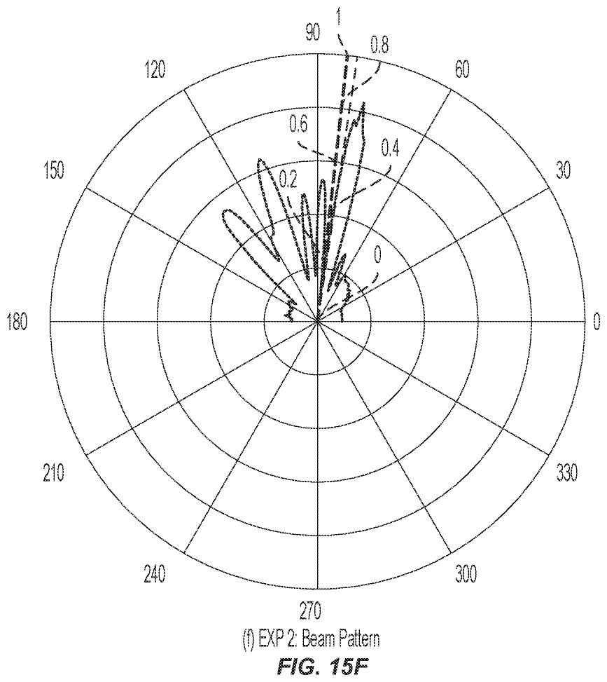

As shown in FIG. 13A, we build a test platform comprised of a receiver, a transmitter, and an interferer. The radio frontend of all three components is the same type of mmWave phased array, which employs a 16-antenna uniform linear array (ULA) and transmits/receives signals at an operating frequency of 62.64 GHz. The control units of the transmitter and the interferer are identical, while the control unit of the receiver includes a laptop. The laptop is used for several tasks: (i) It controls the phased array at the receiver; (ii) It executes the deep reinforcement learning algorithm; (iii) It connects to a wireless router and can remotely control the transmitter and the interferer. During the measurement, it controls the on/off status of the transmitter. It is worth mentioning that although the transmitter and interferer are equipped with phased arrays, they both transmit signals in an omnidirectional way for an effective and fair evaluation of the disclosed algorithm. For the phased array at the receiver, only 2 bits are used for the phase encoding of each phase shifter to form the directional beam, which means that the signal received by each antenna can only be adjusted with 4 different phase values.

FIG. 13A and FIG. 13B show the prototyping setup and the outdoor measurement environment for evaluating the disclosed interference-aware beam pattern design algorithm. The adopted setup consists of a receiver, a desired transmitter and an interferer, as shown in (FIG. 13A). The upper right figure in (FIG. 13A) shows the EXP-1 of the conducted measurement campaign, as depicted in (FIG. 13B), where we provide an illustration of the relative positions of the receiver, transmitter and interferer in the outdoor measurements.

ii. Experiment Description

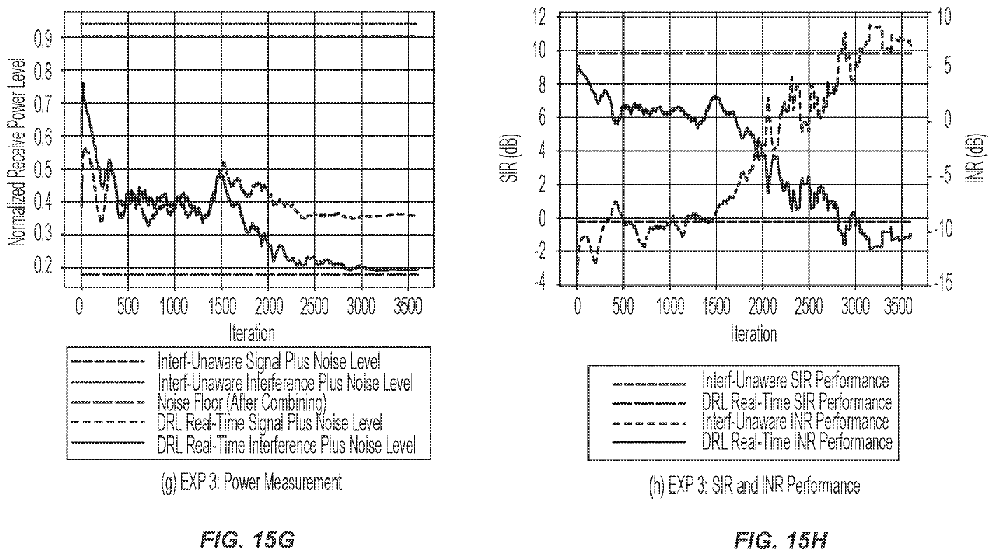

In this subsection, we describe in detail how the experiments are designed to effectively evaluate the performance of the disclosed algorithm. As can be seen in FIG. 13A, we consider the scenario where both transmitter and interferer have a direct LOS connection with the receiver. To better reflect the interference suppression capability, we first turn on only the transmitter and use the algorithm disclosed in [5] to learn the “interference-unaware” beam, which focuses only on maximizing the receive power from the desired transmitter. Then, we turn on the interferer and run the algorithm disclosed in Section C. This forms the “interference-aware” beam, which focuses on maximizing the SINR performance. For a better understanding of the measurement results, we also depict the relative positions of the receiver, transmitter and interferer in FIG. 13B. It is worth pointing out that, during the measurement, we fixed the positions of the transmitter and receiver, which maintains a distance of 9.12 m. We change the position of the interferer to get multiple angle differences that are of interest between the two LOS links. For example, as shown in FIG. 13B, in the EXP-1, the distance between the receiver and the interferer is 10.08 m, and the distance between the transmitter and the interferer is 6.68 m, which forms an angle difference of around 40.330 from the receiver's point of view. Finally, we also visualize all the learned beams by measuring their patterns in an anechoic chamber as shown in FIG. 14B, which provides useful information in understanding and validating the achieved performance.

FIG. 14A, FIG. 14B, FIG. 14C shows the learning results of the interference-unaware beam pattern, where (FIG. 14A) shows the real-time power measurement, (FIG. 14B) shows the anechoic chamber setup for measuring the learning beam pattern, and (FIG. 14C) shows the learned beam pattern with the black dashed line representing the direction of the desired signal and the red dashed lines representing the directions of the interfering sources which will be presented later.

TABLE II
Performance of the Interference-Unaware Beam

| | EXP-1 | EXP-2 | EXP-3 |
|---|---|---|---|
| Angular | 40.33° | 2.16° | 21.3° |
| Separation | | | |
| Signal Plus Noise | 0.92 | 0.86 | 0.903 |
| Level | | | |
| Interference Plus | 0.32 | 0.915 | 0.94 |
| Noise Level | | | |
| SIR Performance | 6.96 dB | −0.33 dB | −0.33 dB |
| INR Performance | −0.47 dB | 6.56 dB | 6.29B |

iii. Measurement Results

In FIG. 14A, we plot the learning process of the interference-unaware beam pattern, where the real-time performance of the DRL-based beam pattern learning algorithm is presented. To better understand the learning process and make sure that the learning result is meaningful, we compare the performance achieved by the learned beam with a built-in beam codebook. To be more specific, the phased array adopted in the experiment includes a default codebook that has 64 beams. This codebook is essentially a beamsteering-like codebook with its beams covering −45° to +45° azimuth angular space. In order to find the beam with the best performance, we perform a beam sweeping and calculate the receive power after combining by each of the beams. The one that achieves the highest receive power is determined as the best beam. As can be seen in the FIG. 14A, the learned beam finally achieves a normalized receiver power of around 0.9, significantly outperforming the best beam in the codebook. Moreover, we also measure the beam pattern of the learned interference-unaware beam (plotted in FIG. 14C) in an anechoic chamber as shown in FIG. 14B. After the interference-unaware beam is learned, the beam weights are saved and the interferer is turned on. We then measure the signal and interference levels (with noise) of this learned interference-unaware beam. It is worth mentioning that the interference levels also depend on the position of the interferer. In our experiments, we select 3 different interferer positions. The measurement results of the interference-unaware beam with the different interferer placements are summarized in Table II.

The performance of the interference-aware beam pattern learning algorithm is then benchmarked with that of the interference-unaware beam. Before we delve into the detailed measurement results, it is worth pointing out that, since both the transmitter and the interferer have a direct LOS connection with the receiver, and given the channel characteristics in the mmWave bands, it is reasonable to assume that the existing LOS link has stronger power than the other NLOS links (if any) and hence is the dominant factor in the learning process. Furthermore, due to the finite number of antennas at the receiver (which leads to the limited angular resolution), intuitively speaking, what really matters is the angle difference between the transmitter-receiver LOS link and the interferer-receiver LOS link. And in general, the “closer” the transmitter and the interferer are, the harder for the receiver to distinguish between them. Specifically, we classify whether a pair of positions (of transmitter and interferer) being well-separated or not by comparing the angle difference with respect to the receiver with the half-power beam-width (HPBW). For a ULA with half-wavelength antenna spacing, the HPBW can be approximately calculated as

$$\frac{1.78}{N}$$

rad with N being the number of antenna elements [34]. Therefore, the HPBW of our adopted 16-antenna phased array is around 6.37°. Next, based on the angular separation of the transmitter and the interferer of the considered scenarios (i.e., FIG. 13B), we divide the measurement results into two categories and discuss them respectively.

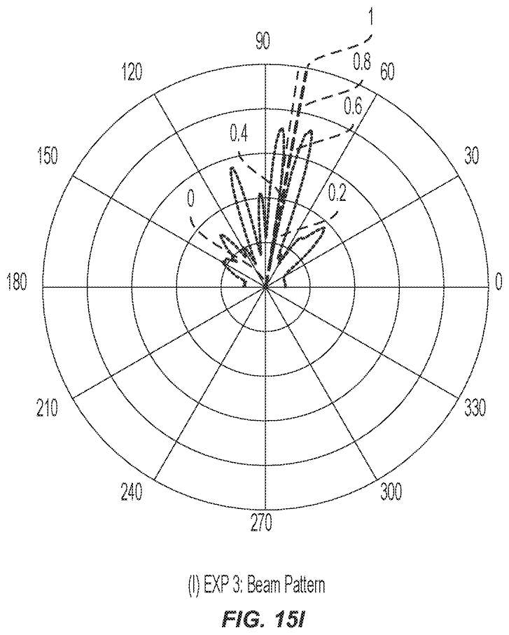

1) When the transmitter and the interferer are well-separated: We first study the case when the transmitter and the interferer are relatively well-separated, i.e., the angular separation is greater than that of the HPBW, in the experiment 1 (EXP 1 in FIG. 13B). In FIG. 15A and FIG. 15B, we plot the learning process of the experiment 1, where the angular separation of the transmitter and the interferer is around 40.33°. As can be seen in the figure, the performance of the interference-unaware beam is actually quite decent, yielding a SIR of 6.96 dB and a INR of −0.47 dB, thanks to the significant angular separation. However, it still introduces a certain level of interference which makes it comparable to the noise level and raises the interference plus noise level noticeably above the noise floor. By contrast, the learned interference-aware beam is able to further suppress the interference to a great extent, making the INR even below −10 dB, i.e., achieving a nearly 10 dB gain in INR, while only sacrificing around 10% of the desired signal power. It is also worth mentioning that such performance is achieved with only 3,500 iterations and without knowing the channels of both the desired transmitter and the interferer. Such relaxation on the system operations (such as synchronization and channel estimation) makes the disclosed solution implementation friendly in most of the practical systems.

FIG. 15A, FIG. 15B, FIG. 15C, FIG. 15D, FIG. 15E, FIG. 15F, FIG. 15G, FIG. 15H, and FIG. 151 show measurement results of the three experiments illustrated in FIG. 13B, where the first column of figures shows the real-time receive power measurements and the second column of figures shows the corresponding SIR and INR performance. All these results are processed with a moving average of 100 samples to smooth out the effect of noise. Finally, the third column of figures shows the learned interference-aware beam patterns with the black dashed line representing the direction of the desired signal and the red dashed line representing the direction of the interfering source.

2) When the transmitter and the interferer are extremely close: Next, we study the case when the transmitter and the interferer are extremely close, i.e., the angular separation is much smaller than the HPBW, in the experiment 2 and 3 (EXP 2 and 3 in FIG. 13B). The angular separations of the transmitter and the interferer in both experiments are around 2°, which is only one third of the HPBW of the adopted phased array receiver. It turns out that the disclosed algorithm is still quite capable of suppressing the interference level. As can be seen in FIG. 15E and FIG. 15H, the SIR in both experiments all finally reaches over 10 dB, and the INR level is also reduced to −8 dB and −10 dB respectively, achieving almost the similar performance when the transmitter and the interferer are well-separated. However, different from the previous case, such great SIR and INR performances are traded with the significant sacrifices of the desired signal power. As indicated in FIG. 15D and FIG. 15G, the signal power is only around 50% of that achieved in experiment 1, for instance. This also implies that when the directions of the signal and interference are well aligned, the system normally needs to strike a delicate balance between SIR and SNR performances, in order to yield a meaningful SINR value. Such observation is also empirically confirmed by the measured learned beam patterns. As can be seen from FIG. 15F and FIG. 15I, the receiver intelligently shapes deep nulls towards the directions of the interference, which explains the achieved well interference suppression capability. However, as a compromise, the main-lobes of the beams are no longer pointing towards the desired transmitter, leaving only the side of the main-lobes leveraged to serve the target transmitter. This makes the receive signal power much weaker than that of the interference-unaware beam. In summary, the real-world prototype confirms the effectiveness and robustness of the disclosed solution in learning interference nulling beam patterns based solely on the power measurements. It also shows the promising gains brought by the intelligent online beam learning solution in realistic scenarios when compared with the off-the-shelf beams.

### G. Conclusion

In this disclosure, a sample-efficient online reinforcement learning based approach is disclosed that can efficiently learn interference-aware beams. The disclosed solution learns how to design beam patterns that can effectively manage interference, relying only on the power measurements and without any channel knowledge. This solution also relaxes the coherence/synchronization requirements of the system and respects the key hardware constraints of practical mmWave transceiver architectures. The results show that the disclosed solution is capable of shaping nulls towards the interfering directions while maximizing the reception quality of the desired signal. When tested on a hardware proof-of-concept prototype based on real-world measurements, the disclosed interference-aware beam learning framework also demonstrating efficient beam pattern optimization performance. Specifically, the developed solution was shown to improve the SNR and INR performance by at least 10 dB compared to the interference-unaware beams in all the tested scenarios. This is particularly noted when the interferer is close to the transmitter. These SNR/INR gains can be translated to more than double the data rate in the considered scenarios.

### DI. Computer System

FIG. 7 is a block diagram of a computer system 700 suitable for implementing the interference-aware beam pattern design framework 10 according to embodiments disclosed herein. The computer system 700 comprises any computing or electronic device capable of including firmware, hardware, and/or executing software instructions that could be used to perform any of the methods or functions described above, such as designing an interference-aware beam pattern. In this regard, the computer system 700 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 700 in this embodiment includes a processing device 702 or processor, a system memory 704, and a system bus 706. The processing device 702 represents one or more commercially available or proprietary general-purpose processing devices, such as a microprocessor, central processing unit (CPU), or the like. More particularly, the processing device 702 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 702 is configured to execute processing logic instructions for performing the operations and steps discussed herein.

In this regard, the various illustrative logical blocks, modules, and circuits described in connection with the embodiments disclosed herein may be implemented or performed with the processing device 702, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 702 may be a microprocessor, or may be any conventional processor, controller, microcontroller, or state machine. The processing device 702 may also be implemented as a combination of computing devices (e.g., a combination of a DSP and a microprocessor, a plurality of microprocessors, one or more microprocessors in conjunction with a DSP core, or any other such configuration).

The system memory 704 may include non-volatile memory 708 and volatile memory 710. The non-volatile memory 708 may include read-only memory (ROM), erasable programmable read-only memory (EPROM), electrically erasable programmable read-only memory (EEPROM), and the like. The volatile memory 710 generally includes random-access memory (RAM) (e.g., dynamic random access memory (DRAM), such as synchronous DRAM (SDRAM)). A basic input/output system (BIOS) 712 may be stored in the non-volatile memory 708 and can include the basic routines that help to transfer information between elements within the computer system 700.

The system bus 706 provides an interface for system components including, but not limited to, the system memory 704 and the processing device 702. The system bus 706 may be any of several types of bus structures that may further interconnect to a memory bus (with or without a memory controller), a peripheral bus, and/or a local bus using any of a variety of commercially available bus architectures.

The computer system 700 may further include or be coupled to a non-transitory computer-readable storage medium, such as a storage device 714, which may represent an internal or external hard disk drive (HDD), flash memory, or the like. The storage device 714 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 716 and any number of program modules 718 or other applications can be stored in the volatile memory 710, wherein the program modules 718 represent a wide array of computer-executable instructions corresponding to programs, applications, functions, and the like that may implement the functionality described herein in whole or in part, such as through instructions 720 on the processing device 702. The program modules 718 may also reside on the storage mechanism provided by the storage device 714. As such, all or a portion of the functionality described herein may be implemented as a computer program product stored on a transitory or non-transitory computer-usable or computer-readable storage medium, such as the storage device 714, volatile memory 710, non-volatile memory 708, instructions 720, and the like. The computer program product includes complex programming instructions, such as complex computer-readable program code, to cause the processing device 702 to carry out the steps necessary to implement the functions described herein.

An operator, such as the user, may also be able to enter one or more configuration commands to the computer system 700 through a keyboard, a pointing device such as a mouse, or a touch-sensitive surface, such as the display device, via an input device interface 722 or remotely through a web interface, terminal program, or the like via a communication interface 724. The communication interface 724 may be wired or wireless and facilitate communications with any number of devices via a communications network in a direct or indirect fashion. An output device, such as a display device, can be coupled to the system bus 706 and driven by a video port 726. Additional inputs and outputs to the computer system 700 may be provided through the system bus 706 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

1: A method for designing an interference-aware beam pattern, the method comprising:
measuring one or more channels for one or more interfering signals from one or more interference directions;
using reinforcement learning to shape one or more interference-aware beams to reduce interference in one or more directions based on the one or more interfering signals; and
communicating over the one or more channels using the one or more interference-aware beams.

2: The method of claim 1, wherein the measuring further comprises measuring, by a base station, a power level of a received signal from a target user equipment of a target user and measuring an interference power level of one or more undesired transmitters.

3: The method of claim 2, wherein measuring, by the base station, the power level of the received signal from the target user equipment of the target user further comprises measuring a power of an interference plus a noise level signal when the target user equipment is not transmitting and measuring a power of a signal plus the interference plus the noise level signal of the target user equipment using a same beam produced by the target user equipment.

4: The method of claim 3, wherein the power of the interference plus the noise level signal when the target user equipment is not transmitting is obtained from a zero power reference signal transmitted by the target user equipment.

5: The method of claim 2, wherein the reinforcement learning comprises an actor-critic-based deep reinforcement learning architecture.

6: The method of claim 5, wherein the actor-critic-based deep reinforcement learning architecture comprises a fully connected (FC) feed-forward neural network.

7: A beam pattern design system, comprising:
a measurement module configured to measure interference on a channel;
a learning module configured to use reinforcement learning to learn a beam pattern which reduces interference on the channel; and
a beamforming control module configured to apply the beam pattern to communicate with a user device.

8: The beam pattern design system of claim 7, wherein the measurement module is configured to measure, by a base station, a power level of a received signal from a target user equipment of a target user and measuring an interference power level of one or more undesired transmitters.

9: The beam pattern design system of claim 8, wherein the base station measures the power level of the received signal from the target user equipment of the target user by measuring a power of an interference plus a noise level signal when the target user equipment is not transmitting and measuring a power of a signal plus the interference plus the noise level signal of the target user equipment using a same beam produced by the target user equipment.

10: The beam pattern design system of claim 9, wherein the power of the interference plus the noise level signal when the target user equipment is not transmitting is obtained from a zero power reference signal transmitted by the target user equipment.

11: The beam pattern design system of claim 8, wherein the reinforcement learning comprises an actor-critic-based deep reinforcement learning architecture.

12: The beam pattern design system of claim 11, wherein the actor-critic-based deep reinforcement learning architecture comprises a fully connected (FC) feed-forward neural network.

13: A radio frequency (RF) device, comprising:
an RF transmitter;
an RF receiver co-located with the RF transmitter; and
control circuitry configured to:
measure self-interference between the RF transmitter and the RF receiver; and
use reinforcement learning to design a beam pattern or beam codebook that reduces the self-interference and optimizes a performance parameter of the RF device.

14: The RF device of claim 13, wherein the performance parameter comprises a power for a desired user.

15: The RF device of claim 13, wherein the measure further comprises measuring, by a base station, a power level of a received signal from a target user equipment of a target user and measuring an interference power level of one or more undesired transmitters.

16: The RF device of claim 15, wherein measuring, by the base station, the power level of the received signal from the target user equipment of the target user further comprises measuring a power of an interference plus a noise level signal when the target user equipment is not transmitting and measuring a power of a signal plus the interference plus the noise level signal of the target user equipment using a same beam produced by the target user equipment.

17: The RF device of claim 16, wherein the power of the interference plus the noise level signal when the target user equipment is not transmitting is obtained from a zero power reference signal transmitted by the target user equipment.

18: The RF device of claim 13, wherein the reinforcement learning comprises an actor-critic-based deep reinforcement learning architecture.

19: The RF device of claim 18, wherein the actor-critic-based deep reinforcement learning architecture comprises a fully connected (FC) feed-forward neural network.
